(19) United States
(12) Patent Application Publication
(10) Pub. No.: US 2026/0226365 A1
(43) Pub. Date: Aug. 6, 2026

(54) A LIQUID-LIQUID-SOLID EXTRACTION PROCESS FOR RECOVERING PRODUCTS FROM A FEED STREAM CONTAINING BIOMASS

(71) Applicant: Neste Oyj, Espoo (FI)

(72) Inventors: Jeffrey KANEL, Porvoo (FI); Cecilia STILL, Porvoo (FI); Aliisa KOSKINEN, Porvoo (FI); Henri Eemil Petteri SALONEN, Porvoo (FI); David BRYANT, Porvoo (FI)

(21) Appl. No.: 19/142,801

(22) PCT Filed: Dec. 22, 2023
(86) PCT No.: PCT/FI2023/050734

§ 371 Date: Jun. 24, 2025

Related U.S. Application Data
(60) Provisional application No. 63/477,842, filed on Dec. 30, 2022.

(30) Foreign Application Priority Data
Jun. 15, 2023 (FI) 20235673

(51) Int. Cl. C11B 1/10; B01D 1/00; B01D 11/04; B01D 37/00

(52) U.S. Cl. CPC C11B 1/10; B01D 1/00; B01D 11/0484; B01D 11/0492; B01D 37/00; B01D 2257/7022

(57) ABSTRACT

A liquid-liquid-solid extraction process is disclosed for recovering products from a feed stream containing biomass. The process includes receiving the feed stream from a source; contacting the feed stream with a first solvent in a first contacting unit to form a first dispersion; allowing the first dispersion to phase separate into a first separated liquid phase and a first remaining dispersion; removing at least a portion of the first separated liquid phase; contacting the first remaining dispersion with a second solvent in a second contacting unit to form a second dispersion; allowing the second dispersion to phase separate into a biomass-rich phase, a heavy separated liquid phase and a light separated liquid phase; and recovering at least one or more of the biomass-rich phase, the heavy separated liquid phase, and/or the light separated liquid phase for output as products. Systems for performing this process and methods for designing this process are also disclosed.

### FIELD

The present disclosure relates to a liquid-liquid-solid extraction process for recovering products from a feed stream containing biomass. A system for recovering products from a feed stream containing biomass via a liquid-liquid-solid extraction process is also disclosed herein.

### BACKGROUND INFORMATION

Extraction of valuable components, such as oils and carotenoids, from biomass is known to be accomplished by drying the biomass and then subjecting the dried biomass to a leaching process (which is commonly called dry extraction). With this method, dried biomass is intimately contacted with a hydrocarbon solvent, such as hexane, to extract the oils and carotenoids. The spent biomass, depleted in oil and carotenoids, is separated from the extract by a solid-liquid separation process such as filtration and/or pressing. When algal biomass is extracted using this leaching process, the algal biomass is first dried and often pelletized before the leaching process can be utilized. Significant energy is involved in drying the algal biomass prior to dry extraction because a mechanical separation process can only concentrate algal biomass to about 10-20 wt % biomass in a wet paste. Having to remove 80 to 90% of the weight of the wet paste by drying is an overwhelming negative from a greenhouse-gas generation perspective. Therefore, extracting the valuable components from a wet biomass (which is commonly called wet extraction), without thermal drying of the algal biomass prior to the extraction, becomes of interest.

Solvent extraction of wet algal biomass (a liquid-liquid-solid extraction) is typically performed in a mixer-settler unit. With the large volume flows required for the algae process, the settler size sets the economics. As the volume of the mixer-settler unit increases, the capital cost and solvent hold-up increases, both of which are critical considerations to the mixer-settler design. If the settler performance can be significantly improved, the mixer-settler economics become more attractive.

There is an increasing interest in using algal biomass as a key intermediate for a plethora of sustainable products, such as a source of renewable energy, as a mode to safely and efficiently capture carbon dioxide from the atmosphere for carbon sequestration, as a source of natural carotenoids and as a renewable source of chemical intermediates. For example, an algal concentrate that is produced by a harvester is often passed through an extraction process to separate the algal oil from the algal biomass. The algal oil can be a source of valuable products including carotenoids, fatty acids, and other lipids. The algal biomass can also be a source of valuable products, including protein, animal feeds, soil builder, feed for fermentation, and fuel. A more robust extraction for the separation of oil and carotenoids from algae would allow products to be obtained with high purity and high yields. The more robust extraction also maximizes the economic return from the venture.

To address the foregoing issues, a more economical and efficient process for isolating natural products from a biomass is desirable whereby, for example, an industrial scale, robust extraction can be achieved.

### SUMMARY

A liquid-liquid-solid extraction process for recovering products from a feed stream containing biomass is disclosed herein, the liquid-liquid-solid extraction process including: receiving the feed stream from a source; contacting the feed stream with a first solvent in a first contacting unit to form a first dispersion; allowing the first dispersion to phase separate into a first separated liquid phase and a first remaining dispersion; removing at least a portion of the first separated liquid phase; contacting the first remaining dispersion with a second solvent in a second contacting unit to form a second dispersion; allowing the second dispersion to phase separate into a biomass-rich phase, a heavy separated liquid phase and a light separated liquid phase; and recovering at least one or more of the biomass-rich phase, the heavy separated liquid phase, and/or the light separated liquid phase for output as products.

A system for recovering products from a feed stream containing biomass is disclosed herein, the system including: a feed stream import line; a first contacting unit in communication with the feed stream import line; a first solvent import line in communication with the first contacting unit; a first effluent export line in communication with the first contacting unit; a second contacting unit in communication with the first contacting unit; and a first extraction line in communication with the second contacting unit.

A system configured for recovering products from a feed stream containing biomass is disclosed herein, the system including at least one or more of the following components: a feed stream import line configured for delivering the feed stream to a first contacting unit; a first contacting unit configured for receiving the feed stream from the feed stream import line and a first solvent from a first solvent import line, the first contacting unit including (i) a first means configured for separating the feed stream into a first separated liquid phase and a first remaining dispersion, (ii) a second means configured for removing at least a portion of the first separated liquid phase from the first remaining dispersion and (iii) a third means configured for transferring the first remaining dispersion to a second contacting unit; a second contacting unit including (a) a fourth means configured for separating the first remaining dispersion into a biomass-rich phase, a heavy separated liquid phase and a light separated liquid phase and (b) a fifth means configured for removing at least one or more of the biomass-rich phase, the heavy separated liquid phase and the light separated liquid phase from the second contacting unit.

A method for designing a liquid-liquid-solid extraction process for recovering products from a feed stream containing biomass is disclosed herein, the method including: intimately contacting the feed stream and a first extraction solvent in a first contacting unit and measuring the decantation curves that form upon and/or during contact in a first separating unit; selecting a phase with the shortest time to reach 90% of a dimensionless height asymptote and removing a desired amount of said phase from the first separating unit before passing a first remaining dispersion to a second contacting unit; intimately contacting the first remaining dispersion with a second solvent and determining the decantation curves formed upon and/or during contact in the second contacting unit; and selecting operating parameters for the second contacting unit and a second separating unit to optimize the overall extraction costs of the method.

### BRIEF DESCRIPTION OF THE DRAWINGS

Other features and advantages of the present invention will be apparent to those skilled in the art reading the following detailed description in conjugation with the exemplary embodiments illustrated in the drawings, wherein:

FIG. 1 shows a flow diagram of an exemplary embodiment of a liquid-liquid-solid extraction process for recovering products from a feed stream containing biomass in an aqueous solution.

FIG. 2 shows a flow diagram of an exemplary embodiment of a liquid-liquid-solid extraction process for recovering products from a feed stream containing biomass in an aqueous solution in extraction columns.

FIG. 3 shows decantation curves for exemplary embodiments of liquid-liquid-solid systems (salt-water/heptane/algal biomass) as a function of temperature. The stars depicted in the graph indicate that time when phase separation was essentially complete.

FIG. 4 shows a decantation profile depicting the top and bottom interface locations in terms of dimensionless depth for the liquid-liquid-solid system in the first extraction step of Example 10. The biomass layer is located at the interface between the first extract (top layer) and the first raffinate (bottom layer).

FIG. 5 reveals a decantation curve showing settling of a liquid-liquid-solid system in a mixer-settler extraction system shown as dimensionless height of the layers vs. settling time.

### DETAILED DESCRIPTION

According to an embodiment, the present liquid-liquid-solid extraction process for recovering products from a feed stream containing biomass comprises receiving the feed stream from a source; contacting the feed stream with a first solvent in a first contacting unit to form a first dispersion; allowing the first dispersion to phase separate into a first separated liquid phase and a first remaining dispersion; removing at least a portion of the first separated liquid phase from the first remaining dispersion; contacting the first remaining dispersion with a second solvent in a second contacting unit to form a second dispersion; allowing the second dispersion to phase separate into a biomass-rich phase, a heavy separated liquid phase and a light separated liquid phase; and separating at least one or more of the biomass-rich phase, the heavy separated liquid phase, and/or the light separated liquid phase for output as recovered products.

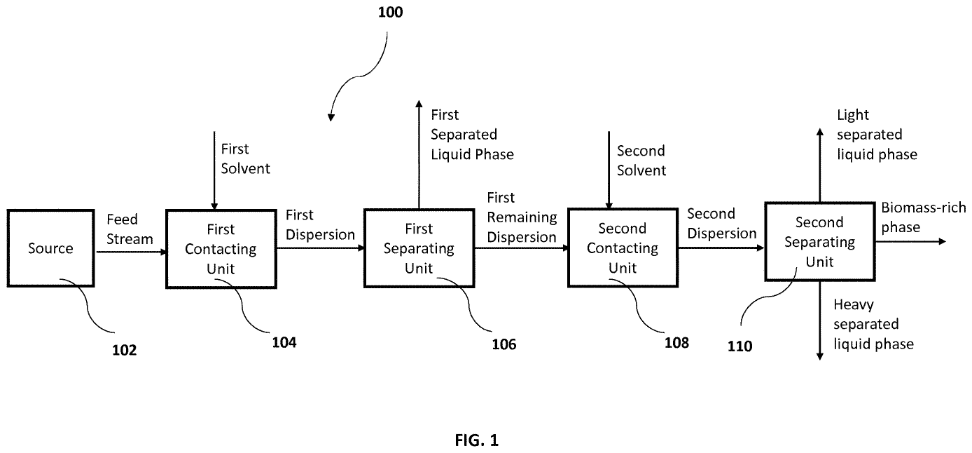

FIG. 1 shows an exemplary embodiment of a liquid-liquid-solid extraction process (100) for recovering products from a feed stream containing biomass in an aqueous solution. In this embodiment, a feed stream originating from a source (102) is received by a first contacting unit (104).

The expression “feed stream” refers to a liquid phase that contains a solid material as a liquid-solid dispersion or paste. The solid material can contain or is a biomass material, for example, an algal biomass material.

In exemplary embodiments, the feed stream is received from at least one or more of a plant, an algae, a micro-organism, a bacteria, or a microalgae feedstock source. Suitable plant feedstock sources can be derived e.g. from plant matter that is ground or chopped into a puree or a dispersion of small biomass particles in a liquid slurry. Suitable algae or microalgae feedstock sources can be derived from reactors that include, but are not limited to, tubular reactors, photobioreactors, enclosed raceways, covered ponds, open raceways, open ponds, earthen ponds, ponds in greenhouses, clear plastic bags hung either indoors or outdoors, fermenters, naturally occurring bodies of water, solar salt ponds, and combinations thereof.

In exemplary embodiments, the feed stream is freshly prepared. A “freshly prepared feed stream” as used herein, can include, but is not limited to, a feed stream that either has been harvested within 1 to 7 days, or a feed stream that has been harvested, then frozen and thawed within 1 day to 7 days.

In exemplary embodiments, the feed stream undergoes conditioning and/or concentration processes before being received by the first contacting unit. Suitable conditioning and concentration processes can include, but are not limited to, fracking, adsorptive bubble separation, filtration, deep bed filtration, belt pressing, screw pressing, centrifugation, adsorption, sedimentation, mechanical flotation, froth flotation, flocculation and combinations thereof. Examples of these and other conditioning and concentration processes and equipment which can be used to condition the feed stream can be found in U.S. Pat. Nos. 5,541,056; 4,554,390; 4,115,949; 5,951,875; 4,680,314; 6,524,486; 6,405,948; 5,776,349; 6,000,551; 8,512,998; 4,397,741; 4,938,865; 5,188,726; 5,332,100; WO 2008/156,795; WO 2008/156,835; U.S. Pat. Nos. 4,981,582; 5,167,798; all the contents of which are incorporated herein by reference in their entireties.

In exemplary embodiments, the feed stream is conditioned and then concentrated by one or more concentration processes before being received by the first contacting unit.

The feed stream or the biomass included in the feed stream can also be subjected to a cell rupturing or conditioning process before being received by the concentration step and/or the first contacting unit. The feed stream can include cellular material, e.g., biomass, which contains natural products. In these instances, rupturing the cell wall and/or cell membrane of the cellular material can release or accelerate the extraction of natural products that can be purified in later processes. Cell rupturing or conditioning can be achieved by a number of methods which include, but are not limited to, chemical, physical or mechanical methods. Chemical methods can include enzymatic digestion, detergent solubilization, lipid dissolution with a solvent, and alkali treatment (lipid saponification). Physical methods can include osmotic shock, decompression, sonication, heat treatment, and freeze-thawing. Mechanical methods can include grinding, high shear homogenization, passing the feedstock stream across a pressure drop, and pressure extrusion.

Other cell disruption processes which can be used to condition the feed stream or the biomass included in the feed stream include pumping the feed stream at high pressures through a restricted orifice valve. An equipment which can perform this disruption method is, for example, the MICROFLUIDIZER™ cell disruption equipment of Microfluidics, Newton, MA, US, which utilizes pressures of about 5,000 to 40,000 psig (345-2760 bar).

A mill, such as a vibratory mill, can also be used to condition the feed stream by rupturing the cellular and/or biomass material in the feed stream. A suitable conditioning process that can be used to condition the feed stream with a mill is disclosed in U.S. Pat. No. 8,512,998, the contents of which are incorporated herein by reference in their entirety.

In exemplary embodiments wherein the feed stream contains algae or microalgae, fracking processes can be performed on the feed stream before the feed stream is received by the first contacting unit. The partial rupturing of algae is referred to as fracking. The use of fracked algae in the liquid-liquid-solid extraction processes disclosed herein can be more advantageous than the use of completely ruptured algae due to the difference in size of the resulting particles. Particles resulting from fracking algae are larger than the particles resulting from the complete rupturing of algae and thus adsorptive bubble separation conditioning processes could be more effective when larger particles are present. Fracking the algae or microalgae can produce fracked cells possessing hydrophobic components while still retaining a significant portion of the intracellular material within the cellular membrane. This can result in increased recovery of the intracellular material. Fracking can take place in any device known in the art in which algae or microalgae can be partially ruptured including, but not limited to, a vibratory mill, a French press, a pump, an agitated vessel, or combinations thereof.

Suitable concentration processes include, but are not limited to sedimentation, adsorption, deep bed filtration, filtration, centrifugation, adsorptive bubble separation processes, and combinations thereof.

Sedimentation concentration processes can include the addition of alum and/or lack agitation of the feed stream. For example, Haematococcus pluvialis can be separated from algal growth medium by sedimentation resulting from the addition of alum or the lack of agitation of the algal growth medium. U.S. Pat. No. 5,541,056, the contents of which are incorporated herein by reference in their entirety, discloses a method of concentrating Haematococcus pluvialis by sedimentation. The sedimentation methods as taught in U.S. Pat. No. 4,115,949, the contents of which are incorporated herein by reference in their entirety, can also be used to concentrate the feed stream. The addition of ferric chloride may also be included in sedimentation conditioning processes to cause flocculation. Any polymer or ion that causes flocculation can also be used during sedimentation conditioning processes. Cyclones can also be used to accelerate the rate of sedimentation. Any sedimentation equipment known in the art can be used to condition the feed stream before being received by the first contacting unit and/or separate flocculated products from the feed stream, optionally prior to an adsorptive bubble separation conditioning process.

Centrifugation is another suitable concentration process that can be combined with other processes, for example, sedimentation as taught in U.S. Pat. No. 4,115,949, the contents of which are incorporated herein by reference in their entirety, to concentrate the feed stream. Sedimentation and centrifugation may be used either individually or in combination in order to generate an aqueous suspension of microalgae. Centrifuges known in the art may be used to affect algal preconcentration in the feed stream, as long as they can readily handle solids. Suitable centrifugation equipment can also be constructed from acceptable materials of construction in order to handle the ions present in the feed stream. When the feed stream includes sodium chloride, stainless steel and/or plastic wetted parts on the centrifuge are present for robust operations. However, it should be noted that stainless steel is susceptible to stress corrosion cracking in a chloride environment. Suitable centrifuges known in the art include, but are not limited to those produced by Westfalia, Robatel, Bird, and Alfa Laval. Disc-stack centrifuges produced by Westfalia and Alfa Laval can also be used.

Deep bed filtration may be used to concentrate the feed stream prior to being received by the first contacting unit and, optionally, prior to other concentration processes, e.g., an adsorptive bubble separation process. The deep bed filtration methods disclosed in U.S. Pat. No. 5,951,875, the contents of which are incorporated herein by reference in their entirety, can be used to concentrate the feed stream. Deep bed filtration relies upon a bed of granular media, usually sand, through which the feed stream containing products flows downward under gravity. The products are deposited in the pores of the granular media and in the interstitial spaces between the grains of media. Deep bed filtration should not be confused with straining filtration. Straining takes place on the surface of a mesh or fabric, and is only suitable to pre-concentrate a feed stream with products that will not blind the filtration equipment. However, deep bed filters retain particles throughout their volume, with each pore and void space having a probability of retaining cellular material from the feed stream that is flowing through. Suitable deep bed filtration media include those used in commercial processes, for example, quartz sand, garnet sand, anthracite, fiberglass, and mixtures thereof.

Adsorption can be used as a concentration process to reduce the volumetric flow of the feed stream to the first contacting unit. Some feed streams, for example those containing Dunaliella salina, can be conditioned and then concentrated via adsorption to where the algae are adsorbed onto a hydrophobic surface, and then desorbing the algae with another fluid. Thus, adsorption may be used to preconcentrate the feed stream.

The adsorptive bubble concentration processes can optionally include the use of an additive, which can include, but is not limited to, a flotation aid, a frother, a collector, an activator, and combinations thereof. The feed stream can be conditioned prior to being concentrated in an adsorptive bubble separation unit.

Collectors selectively render one or more of the species of particles in the feed hydrophobic, thereby assisting in the process of collection by gas bubbles. Activators aid the adsorption of the collector to certain particles increasing the number of those particles which become hydrophobic. Depressors inhibit the adsorption of the collector to certain undesired particles decreasing the number of those particles which become hydrophobic. Also, frothing agents and frothers may be added to the feedstock stream to assist in the formation of a stable froth on the surface of a liquid.

Adsorptive bubble concentration processes can include a step of rendering materials or products within the feed stream hydrophobic by treating particle surfaces with chemicals, or other techniques that selectively modify the material or natural products to be separated. In some cases, the particles or products are not initially hydrophobic, and need to be rendered hydrophobic to be separated or harvested from the feed stream. In other cases, the particles are all hydrophobic, and one component is modified to make it hydrophilic in order to keep it in the feed stream. The surface of the cellular material, e.g., microalgae cells, in the feed stream can be hydrophilic, therefore adsorptive bubble separation is less effective on whole, live microalgae cells without the addition of frothers and collectors. Often in order to use adsorptive bubble separation for dewatering microalgae, the microalgae cells must be conditioned to make them hydrophobic.

Suitable adsorptive bubble separation technology that can be used to concentrate the feed stream can be based on selective adsorption of the cellular material in the feed stream to the surfaces of gas bubbles passing through the feed stream. Bubbles rise to form a froth that carries the algal material off overhead. Adsorptive bubble separation processes are suitable for removing a small mass of cellular material from a large volume of the feed stream. There are a variety of adsorptive bubble separation techniques, in some of which a froth is generated and in some of which no froth is generated. One useful adsorptive bubble separation technique for concentrating the feed stream is a dispersed gas flotation technique termed “froth flotation”.

Suitable froth flotation devices for use as roughers, scavengers, or cleaners, include the commercially available equipment used for gas and liquid contact. These devices, which are also called “cells”, may be classified into two broad groups, mechanical and pneumatic flotation cells. The mechanical flotation cells can include a rotor and stator mechanism for dispersing the gas and providing efficient bubble and algae contact.

Pneumatic flotation cells can be most easily distinguished from mechanical flotation cells by the absence of a rotating impeller in the flotation device. In pneumatic flotation cells, bubble and cellular material collisions are produced by addition of gas only, without any moving parts. Pneumatic flotation cells may operate as roughers, cleaners, and scavengers and the operating conditions for each service will require slightly different operating parameters in order to optimize the flotation circuit.

Pneumatic and mechanical flotation cells may be used at any or all of the locations in a froth flotation circuit, depending on equipment performance and separation objectives. However, the pneumatic flotation cells can have advantages over mechanical cells. Higher recovery and throughput may be attained in a pneumatic device as compared to a mechanical device for a given equipment volume and energy input, which usually results in reduced capital and operating costs. Pneumatic devices can be produced from light weight, inexpensive plastics for cost savings and to promote mobility.

Mechanical flotation cells can employ a rotor and stator mechanism for flotation gas induction, bubble generation, and liquid circulation providing for bubble and cellular material collision. The ratio of vessel height to diameter, termed the “aspect ratio”, usually varies from about 0.7 to 2. Four or more cells, each having a centrally mounted rotor and stator mechanism, can be arranged in series to approach substantially perfect mixing and thereby to minimize liquid phase short circuiting. An auxiliary blower can be installed to provide sufficient gas flow to the cell. Mechanical cells may be sealed if desired to facilitate operation to control the flow of the flotation gas.

The flotation gas is dispersed into fine bubbles by a rotating impeller, which serves as the bubble generator. The rotating impeller creates a low-pressure zone that induces gas to flow through an aspiration tube into the collection zone where it is dispersed into fine bubbles and mixed with the algal biomass as it is circulated from the bottom of the cell.

The cellular material in the feed stream can enter the mechanical cell through a feed box. Bubble and cellular material collisions result from turbulence generated by the rotating impeller. The bubble and cellular material agglomerates pass out of the collection zone into the separation zone, which is relatively quiescent, where they float to the surface and separate from the liquid phase.

The bubble and cellular agglomerates are separated from the liquid phase by gravity and collect as froth concentrated in biomass at the top of the cell in the froth zone. Froth concentrated in biomass is withdrawn as a concentrated feed stream. The froth normally overflows the cell into a collection launder. Alternatively, the froth may be withdrawn by mechanical means, for example, a froth paddle. The liquid phase is recirculated to the collection zone and eventually exits the cell as a recycle tails stream of brine depleted in algal biomass.

The properly designed rotor and stator mechanism entrains the proper amount of flotation gas, disperses it into fine bubbles, and mixes the flotation gas with liquid to accomplish sufficient contact between the cellular material in the feed stream and the bubbles. Good mixing and sufficient liquid residence time are necessary in the two phase mixing region to provide high bubble and cellular material collision efficiency, and good flotation performance.

The mechanical and pneumatic flotation cells described herein can have several operating parameters in common, including the gas phase superficial velocity, Jg; the gas to feed ratio; the liquid residence time in the flotation device; flotation aid dosage; and the nature of the flotation gas. Several design parameters are also common to various froth flotation devices, including the aspect ratio of a collection zone; the aspect ratio of a separation zone; the process of phase contact, including cocurrent flow, countercurrent flow, crossflow, and mechanical mixing; the process of separating the bubble and cellular material agglomerates from the pulp; and the process of bubble generation.

J_{g} is defined in a mechanical flotation cell as the volumetric gas flow rate divided by the cell cross sectional area parallel to the froth and liquid interface. As the value of J_{g} increases, the gas holdup increases in the liquid phase and decreases in the froth, resulting in potentially faster flotation kinetics but reduced cellular material concentration in the froth on a flotation gas free basis. The values of J_{g} range from about 0.1 to 5 cm/s for recovery of cellular material. Values of from about 2 cm/s to 4 cm/s can also be used.

The liquid residence time is defined as the volume of the dispersion in the mechanical cell divided by the volumetric liquid flow rate. Longer residence times enable higher recovery of cellular material in the froth. The residence time ranges from about 3 to 60, or 3 to 30 minutes for continuous operation for the recovery of cellular material. Residence times greater than 5 minutes can also be employed.

The advantages of a low flotation gas to feed ratio include reduced equipment volume and blower costs in the mechanical cell. The flotation gas to feed ratio ranges from about 1 to 40 for the recovery of cellular material. Flotation gas to feed ratios of from about 5 to 15 can also be employed.

Impeller tip speed influences the bubble size and the recirculation rate through the collection zone. The bubble size decreases and the recirculation rate through the collection zone increases as the tip speed increases. However, higher tip speeds result in greater mechanical wear and power requirements for the impeller drives. The bubble and cellular material agglomerates may be broken at high tip speeds. Tip speeds range from about 900 to 2500 feet per minute for the recovery of cellular material. Tip speeds of from about 1500 to 1800 feet per minute can also be employed.

There are four primary geometrical parameters for mechanical flotation cells. These geometrical parameters are the ratio of rotor submergence to liquid depth, the ratio of tank diameter to impeller diameter, the ratio of liquid depth to tank diameter, and the design of the rotor and stator mechanism. The ratio of rotor submergence to liquid depth ranges from about 0.7 and 0.75 for the recovery of cellular material. The ratio of tank diameter to impeller diameter ranges from about 1.5 to 5.5. A tank diameter to impeller diameter ratio of about 2 can also be employed. The ratio of liquid depth to tank diameter ranges from about 0.6 to 0.9. A ratio of liquid depth to tank diameter of from about 0.8 to 0.9 can also be employed.

Rotor and stator mechanisms can include those produced by Dorr-Oliver Incorporated of Millford, Conn; Denver Equipment Company which is a division of Svedala of Colorado Springs, Colo.; Wemco Products of Salt Lake City, Utah; and Outotec of Espoo, Finland.

An example of the use of flocculation followed by adsorptive bubble separation concentration was disclosed in U.S. Pat. No. 4,680,314, the contents of which are incorporated herein by reference in their entirety. U.S. Pat. No. 6,524,486, the contents of which are incorporated herein by reference in their entirety, also utilizes a flocculating agent to cause accumulations of microalgae that are then floated out using an adsorptive bubble process.

Pneumatic flotation cells differ from mechanically agitated cells in several respects. Bubbles are generated by any nonmechanical means known to the art in a pneumatic cell. Bubbles can be produced by a perforated pipe sparger, an orifice plate, a venturi, or a static mixer. A frother solution usually is mixed with the gas when a static mixer is used.

Some pneumatic cells generate finer bubbles than do mechanical cells. Therefore, the collision frequency is potentially higher, and the residence time required for the flotation is generally shorter in a pneumatic cell.

Pneumatic flotation cells, especially columns, usually have a higher aspect ratio than mechanical cells. The ratio of vessel height to diameter can be greater in the pneumatic cell. It is possible to operate a pneumatic device with a deeper froth bed, allowing for increased drainage time and a drier, more concentrated froth. Wash water can be added to the froth to improve product purity because the vessel height is usually somewhat greater than the vessel diameter. This use of wash water may optionally be used to improve the removal of salt, extraction solvent, and clay from the cellular material.

Another advantage of a pneumatic flotation cell over a mechanical cell is lighter weight and lower costs of materials and construction. The pneumatic flotation vessel can be constructed of inexpensive lightweight plastics, and weight and cost are reduced by the absence of an impeller and drive. Capital and operating costs for the pneumatic flotation cell may be significantly lower than those for the mechanical cells because no mechanical rotor and stator assembly is required for bubble generation and gas and liquid contacting.

Pneumatic flotation cells can also serve as cleaners operated in either the collection limited regime or in the carrying capacity limited regime. In the collection limited regime, the particle collection rate is limited by the number of collisions between bubbles and the cellular material in the feed stream. In the carrying capacity limited regime the bubble surfaces are saturated with cellular material. Therefore, the particle collection rate is limited by the rate at which bubble surface area is added to the column. It is advantageous to produce a froth whose surface approaches saturation with cellular material because it is desirable to minimize the volume of water sent to the downstream process, which may be a drying step.

The flotation gas is dispersed as fine bubbles by means of a bubble generator in a bubble generation zone. The bubble generator may be either internal or external to the froth flotation device. An example of an internal bubble generator is the perforated pipe sparger. An example of an external bubble generator is a static mixer where the gas is mixed with a frother solution.

The bubbles and the cellular material from the feed stream enter the collection zone where bubble and cellular material collisions occur to form bubble and cellular material agglomerates. Bubble and cellular material collisions may be achieved by countercurrent or cocurrent flow of the flotation gas and liquid phases, or by pneumatic mixing. The agglomerates float through the separation zone to the liquid and froth interface and pass into the froth zone where the gas holdup rapidly increases.

The froth may be contacted with wash water to separate entrained hydrophilic particles, for example, salt, or clay from the cellular material in the froth. The froth leaves the device enriched in cellular material. The liquid passes through the base of the device as an underflow stream depleted of cellular material.

Air or an acceptable flotation gas with recycle may be easily used in pneumatic flotation devices. The flotation gas can be recycled by covering the collection launder. Frother may be added either to the liquid phase or to the gas phase to generate small bubbles.

There are several pneumatic flotation devices available that may be used to concentrate the feed stream. Some of these devices include columns having an aspect ratio greater than one, which provide many of the benefits of the pneumatic devices discussed above.

Suitable pneumatic flotation cells for concentrating the feed stream include, but are not limited to: the air-sparged hydrocyclone, as described in U.S. Pat. No. 4,397,741; the Jameson cell described in U.S. Pat. Nos. 4,938,865, 5,188,726 and 5,332,100; the Canadian column and similar devices with various draft tube designs; the Renewable Algal Energy (RAE) Cell described in WO 2008/156,795 and WO 2008/156,835; and the Microcel™ as defined in U.S. Pat. Nos. 4,981,582 and 5,167,798, the contents of these patents being incorporated herein by reference in their entirety.

Other adsorptive bubble separation techniques that may be useful in the practice of the dewatering technology include electrolytic flotation and dissolved gas flotation. However, it should be recognized that there are practical limits on these processes and that they are not necessarily equivalent to dispersed gas flotation. In electrolytic flotation, bubbles are generated by passing an electric current through the aqueous medium that is to be separated from the cellular material. If the aqueous medium is concentrated brine, then a relatively larger current may be needed to generate the bubbles. In dissolved gas flotation, the gas is dissolved in a portion of the feed stream, under pressure in a separate vessel, and the resulting mixture is then introduced into the flotation vessel. The sudden drop in pressure causes the dissolved gas to nucleate and form small bubbles. The solubility of air in brine is somewhat limited and so another, more soluble gas that does not adversely affect the cellular material may be selected, including, for example, helium. These processes may be suitable and useful in certain cases and for specific cellular materials.

Suitable gases for use in an adsorptive bubble separation include those that are non-toxic and non-hazardous, for example, air, nitrogen, carbon dioxide, helium, argon and other noble gases, which are generally considered chemically inert, and mixtures thereof. An inert gas that does not contain oxygen or oxidizing agents can also be used to avoid oxidation of the lipids and carotenoids present in the algal cell biomass.

The froth flotation devices used for concentrating the feed stream described herein can be used in a flotation circuit to maximize recovery and concentration of the valuable components present in the cellular material. The energy costs for the flotation process are compensated for by the high recovery and concentration factors that may be achieved by using a flotation circuit. Froth flotation devices operate continuously and therefore possess advantages over devices that operate in batch or semi-batch processes. A froth flotation circuit is described in U.S. Pat. No. 5,951,875, the contents of which are incorporated herein by reference in their entirety, for froth flotation columns connected in series of the type that may be used in connection with pneumatic froth flotation. However, it should be understood that the principles represented apply to froth flotation circuits generally, including mechanical and pneumatic froth flotation equipment.

Dissolved air flotation is another suitable adsorptive bubble separation technology for concentrating the feed stream and it can be used without or with the addition of flocculating agents. A process using this technique is disclosed in U.S. Pat. No. 4,680,314, the contents of which are incorporated herein by reference in their entirety. This disclosure teaches how Dunaliella or Chlorella can be concentrated with dissolved air flotation after the addition of a flocculating agent, for example, alum or ferric chloride.

Although not normally necessary, a frother can be used to enhance recovery of the cellular material in froth flotation processes. A frother may be added to the gas or liquid phase prior to entering the froth flotation device or may be added directly to the suspension in the froth flotation device to increase the stability of the froth and to generate small bubbles. Examples of frothers include 2-ethyl hexanol, methyl isobutyl carbinol, which is also known as MIBC, and Dowfroth 250. Dowfroth 250 is a frother that is commercially available from the Dow Chemical Company, which is located in Midland, Mich. When a frother is used, then the frother dosage varies somewhat depending on the manner in which the suspension is dewatered. The frother dosage ranges can range from about 5 to 50 ppm.

However, it should be emphasized that no frothers can be used in froth flotation processes described herein. While not wishing to be bound by theory, it is believed that the feed stream contains cellular material of sufficient concentration and surfactant power to generate small bubbles in the flotation medium.

The cellular material may be conditioned with collectors and depressors to improve the selectivity of the flotation. For example, it may be desirable to increase the selectivity of the bubbles to adsorb cellular material in preference to halotolerant bacteria or other undesirable materials. Collectors unite with the cellular material and attach or adsorb it to the bubble surface so that the cellular material can be removed with the bubble. On the other hand, depressors unite with the undesirable components present in the suspension to substantially preclude their attachment to a bubble. Use of depressors may be desirable where substantial contaminants would otherwise be recovered with the cellular material.

The feed stream can contain algae or microalgae e.g. from the divisions of Chlorophycophyta, Phaeophycophyta, Chrysophycophyta, Cyanophycophyta, Cryptophycophyta, Pyrrhophycophyta and/or Rhodophycophyta, which are adaptable to saline water as a growth medium; or microalgae species selected from, but not limited to, Amphora sp., Anabaena sp., Anabaena flos-aquae, Ankistrodesmus falcatus, Arthrospira sp., Arthrospira (Spirulina) obliquus, Arthrospira (Spirulina) platensis, Botryococcus braunii, Ceramium sp., Chaetoceros gracilis, Chlamydomonas sp., Chlamydomonas mexicana, Chlamydomonas reinhardtii, Chlorella sp., Chlorella fusca, Chlorella protothecoides, Chlorella pyrenoidosa, Chlorella stigmataphora, Chlorella vulgaris, Chlorella zofingiensis, Chlorococcum citriforme, Chlorococcum littorale, Closterium sp., Coccolithus huxleyi, Cosmarium sp., Crypthecoddinium cohnii, Cryptomonas sp., Cyclotella cryptica, Cyclotella nana, Dunaliella sp., Dunaliella bardawil, Dunaliella salina, Dunaliella tertiolecta, Dunaliella viridis, Euglena gracilis, Fragilaria sp., Fragilaria sublinearis, Gracilaria sp., Haematococcus pluvialis, Hantzschia sp., Isochrysis galbana, Microcystis sp., Monochrysis lutheri, Muriellopsis sp., Nannochloris sp., Nannochloropsis sp., Nannochloropsis salina, Navicula sp., Navicula saprophila, Neochloris oleoabundans, Neospongiococcum gelatinosum, Nitzschia laevis, Nitzschia alba, Nitzschia communis, Nitzschia paleacea, Nitzschia closterium, Nitzschia palea Nostoc commune, Nostoc flagellaforme, Pavlova gyrens, Peridinium sp., Phaeodactylum tricornutum, Pleurochrysis carterae, Porphyra sp., Porphyridium aerugineum, Porphyridium cruentum, Prymnesium sp., Prymnesium paruum, Pseudochoricystis ellipsoidea, Rhodomonas sp., Scenedesmus sp., Scenedesmus braziliensis, Scenedesmus obliquus, Scenedesmus quadricauda, Scenedesmus acutus, Scenedesmus dimorphus, Schizochytrium sp., Scytonema sp., Skeletonema costatum, Spirogyra sp., Schiochytrium limacinum, Stichococcus bacillaris, Synechoccus sp., Tetraselmis sp., Tolypothrix sp., and genetically-engineered varieties or combinations (mixtures, or mixed cultures) of these microalgal species. In an exemplary embodiment the algae or microalgae is selected from the group including or consisting of Dunaliella sp., Dunaliella bardawil, Dunaliella kone, Dunaliella salina, Dunaliella bioculata, Dunaliella granulata, Dunaliella maritima, Dunaliella minuta, Dunaliella parva, Dunaliella peircei, Dunaliella polymorpha, Dunaliella primolecta, Dunaliella pseudosalina, Dunaliella quartolecta, Dunaliella terricola, Dunaliella tertiolecta, and Dunaliella viridis. In exemplary embodiments, the algae or microalgae is selected from the group including or consisting of Dunaliella sp., Dunaliella bardawil, Dunaliella salina, Dunaliella kone, Dunaliella tertiolecta, Dunaliella parva and Dunaliella viridis, and any combination thereof. In exemplary embodiments, the algae or microalgae is Dunaliella salina.

The algae or microalgae which can be present in the feed stream can further include any microalgal species (including diatoms, coccolithophorids and dinoflagellates) selected from, but not limited to, Amphora sp., Ankistrodesmus sp., Arthrospira (Spirulina) plantesis, Botryococcus braunii, Chlamydomonas sp., Chlamydomonas reinhardtii, Chlorella protothecoides, Chlorella sp., Closterium sp., Cosmarium sp., Crypthecoddinium cohnii, Cyclotella sp., Dunaliella salina, Dunaliella tertiolecta, Haematococcus pluvialis, Hantzschia sp., Nannochloris sp., Nannochloropsis sp., Navicula sp., Neochloris oleoabundans, Nitzschia sp., Phaeodactylum tricornutum, Scenedesmus sp., Schiochytrium limacinum, Stichococcus sp., Tetraselmis suecica, and Thalassiosira pseudonana, and genetically-engineered varieties or combinations (mixtures, or mixed cultures) of these microalgal species.

The algae or microalgae which can be present in the feed stream can also include algae with flagella, cilia and/or eyespots. Flagella are a tail-like projection that protrudes from the cell body of certain algae and functions in locomotion. Cilia are an adaptation that allows independent cellular creatures, like algae, to move around in search of food. Photosensitive eyespots are found in some free-swimming unicellular algae. Photosensitive eyespots are sensitive to light. They enable the algae to move in relation to a light source. Such algae have the capability of independent motion, phototaxis, and can move towards the surface during daylight. Phototaxis is the movement of microalgae in response to light. For example, certain algae (e.g., Dunaliella) can perceive light by means of a sensitive eyespot and move to regions of higher light concentration to enhance photosynthesis.

The algae or microalgae which can be present in the feed stream also include marine algae that thrive at salt concentrations above that found in seawater. Suitable marine algae can be selected from, but are not limited to, Amphora sp. (diatom), Arthrospira sp., Arthrospira (Spirulina) obliquus, Arthrospira (Spirulina) platensis, Chlorella sp., Chlorella fusca, Chlorella protothecoides, Chlorella pyrenoidosa, Chlorella stigmataphora, Chlorella vulgaris, Chlorella zofingiensis, Dunaliella sp., Dunaliella bardawil, Dunaliella salina, Dunaliella tertiolecta, Dunaliella viridis, Isochrysis galbana, Microcystis sp., Nannochloropsis sp., Nannochloropsis salina, Navicula sp. (diatom), Navicula saprophila (diatom), Nitzschia laevis (diatom), Nitzschia alba (diatom), Nitzschia communis (diatom), Nitzschia paleacea (diatom), Nitzschia closterium (diatom), Nitzschia palea, (diatom), and genetically-engineered varieties or combinations (mixtures, or mixed cultures) of these algal species.

In exemplary embodiments, the algae is a microalgae. In other exemplary embodiments, the algae or microalgae have not been genetically modified or do not originate from genetically engineered algae or microalgae.

The feed stream can include an aqueous solution containing a biomass.

In exemplary embodiments, the aqueous solution is an aqueous salt solution.

The expression “aqueous salt solution” refers to a solution containing water and at least one salt. The salt can be any one or combination of salts found in sea water, terminal lakes, or aquifers. In exemplary embodiments, the aqueous salt solution is or contains the culture medium of the biomass.

The aqueous salt solution can contain concentrations of salts which range from trace amounts to saturating amounts. Suitable terms to describe the salinity or salt concentration of the aqueous salt solution range from fresh water, brackish water, salt water, brine, and saturated brine, respectively, as the salt concentration in the aqueous salt solution increases. The desired concentration of salt in the feed stream will depend on the source of the feed stream.

The expression “salinity” refers to the total amount of dissolved salts in the aqueous salt solution. Salts which can be dissolved and found in the aqueous salt solution include, but are not limited to, those found in natural waters such as sodium chloride, magnesium chloride, calcium and magnesium sulfates, bicarbonates, and carbonates. In general terms, salinity is indicated by the water source, such as a freshwater, a brackish water, a saline water, and a brine. Ranges of salinity are associated with these general terms and these ranges are defined in terms of weight percent as <0.05% for freshwater, 0.05-3% for brackish water, 3-5% for saline water, and >5% for a brine.

Various combinations of ions found in seawater can be included in the aqueous salt solution. Suitable ion combinations may be derived from one or more of the following sources including: water derived from streams, lakes, rivers, or other sources associated with fresh water; water derived from underground aquifers that may contain various ion concentrations; water derived from industrial, agricultural, or municipal sources that may or may not have received treatment; or water derived from brackish sources where fresh water is combined with sea water or ocean water in various proportions; sea water or ocean water that can be derived from the various seas and oceans located around the globe; water derived from terminal lakes; or combinations thereof. The combination of ions for the aqueous salt solution can be derived directly from these sources, or can be derived by evaporating the desired amount of water from any of these sources to leave the desired ion-rich solution for use as the aqueous salt solution. An example of an ion combination source is disclosed in U.S. Pat. No. 6,986,323, the contents of which are included herein by reference in their entirety. Other examples include the evaporation of ancient sea waters that form terminal lakes, such as the Great Salt Lake in Utah, and that form various aquifers. The combination of ions can result up to and include crystallizers wherein sodium chloride ions are precipitated.

The aqueous salt solution can have a salinity that is about 5 wt % or greater than 5 wt %, about 6 wt % or greater than 6 wt %, about 7 wt % or greater than 7 wt %, for example at least about 8 wt %, at least about 9 wt %, at least about 10 wt %, at least about 11 wt %, at least about 12 wt %, at least about 13 wt %, at least about 14 wt %, at least about 15 wt %, at least about 16 wt %, at least about 17 wt %, at least about 18 wt %, at least about 19 wt %, at least about 20 wt %, at least about 21 wt %, at least about 22 wt %, at least about 23 wt %, at least about 24 wt %, or at least about 25 wt %. In exemplary embodiments the aqueous salt solution is saturated with salt, e.g., a salinity of about 26.5 wt % or more. In other exemplary embodiments, the aqueous salt solution can have a salinity that is about 5 wt % to about saturation, from about 10 wt % to saturation, from about 20 wt % to saturation, from about 5 wt % to about 20 wt %, from about 10 wt % to about 20 wt %, from about 5 wt % to about 15 wt %, from about 10 wt % to about 15 wt %, or from about 5 wt % to about 10 wt %.

The biomass contained in the aqueous solution can include or be a plant biomass, a microbial biomass, an algal biomass or any combination thereof.

All of the possible plants and/or microbes which can be included in the feed stream can also be included within the biomass in the aqueous solution.

The biomass can also include or contain some or all of the natural products within the feed stream.

The biomass content in the feed stream can be as low as about 0.05 wt % or greater, for example, greater than 1 wt %. The maximum biomass content in the feed stream is any content that does not impede or prevent the feed stream from being received by the first contacting unit and/or traversing through the liquid-liquid-solid extraction processes disclosed herein. For example, the maximum amount of biomass that the feed stream can possess is about 20 wt %, or less than about 10 wt %.

The feed stream can have a water content before being received by the first contacting unit and/or before being subject to the liquid-liquid-solid extraction processes disclosed herein. The water content can be about 0.1 wt % to about 5 wt %, about 5 wt % to about 10 wt %, about 10 wt % to about 15 wt %, about 15 wt % to about 20 wt %, about 20 wt % to about 30 wt %, about 30 wt % to about 40 wt %, about 40 wt % to about 50 wt %, or about any range within 0.1 wt % to 50 wt % of the total weight of the feed stream. In exemplary embodiments, the feed stream can have a water content that is greater than 50 wt % or about any range within 50 wt % to 99 wt %.

The biomass can include or be a conditioned biomass. As used herein “a conditioned biomass” refers to a biomass that has been treated with one or more of the conditioning processes described herein before either being received by one or more of the concentrating processes described herein, before being received by the first contacting unit and/or before being subjected to the liquid-liquid-solid extraction processes disclosed herein.

The first contacting unit can be, but is not limited to, a mixer-settler, a counter-current extraction column, a co-current extraction column, a centrifugal extractor, a membrane extractor, an emulsion phase contactor and any extractor that employs non-standard contact methods (e.g., extractors that use electrical fields, ultrasonic waves, and/or microwave waves to aid in the extraction of materials) or any combination thereof. Suitable mixer-settlers comprise a mixing section (or contacting unit) and a settling section (or separating unit). Suitable mixers, or contacting units include, but are not limited to static mixers, in-line mixers, agitated vessels, eductors, extraction columns operated in co-current mode, and other means known in the art, and combinations thereof. Suitable settlers or separating units include, but are not limited to gravity decanters, coalescers, electrically enhanced coalescers, cyclones, centrifuges, and other means known in the art, and combinations thereof. Many different designs of mixer-settlers have been developed for mining and minerals applications, and these are described by T. C. Lo et al., (1991) [Handbook of Solvent Extraction, ISBN 0-89464-546-3].

According to an embodiment, the first contacting unit and the second contacting unit are counter-current extraction columns.

Suitable counter-current extraction columns include, but are not limited to, those that are mechanically agitated and those that have stationary internals. The latter is preferred when the extraction solvent is a dense gas and/or the operating pressure of the extractor is elevated so that more expensive mechanical seals are needed. A dense gas is defined as a fluid that is above its critical pressure and close to, but not necessarily above its critical temperature, as described by Stahl et al. in Dense Gases for Extraction and Refining, ISBN 0-387-18158-X, 1988. Suitable dense gases which can be used as the extraction solvent include, but are not limited to, carbon dioxide, ethane, propane, butane, chlorofluorocarbons, and mixture thereof. The dense gas extraction may be operated in any manner known in the art including leaching, batch extraction, and continuous countercurrent extraction e.g. as described in the U.S. Pat. Nos. 6,106,720 and 5,932,101, the contents of which are incorporated herein by reference in their entirety. Additional suitable dense gases can be methane, isobutane, dimethyl ether, sulphur hexafluoride, ammonia, fluorocarbons, and mixtures thereof. Any combination of the above dense gases can also be used, if desired. The dense gases can also contain one or more co-solvents to improve extractability of solutes. Examples of these co-solvents include methanol, ethanol, 1-propanol, 2-propanol, 1-hexanol, 2-methoxy ethanol, acetone, tetrahydrofuran, 1,4-dioxane, acetonitrile, dichloromethane, chloroform, dimethyl sulfoxide, formic acid, carbon disulfide, methylene chloride, amines, chelating agents, phase transfer catalysts and combination thereof. Other examples of dense gases and co-solvents are listed in the U.S. Pat. Nos. 4,345,976 and 5,490,884, the contents of which are incorporated herein by reference in their entirety. The co-solvents may also be added to the feedstock stream to enhance recovery of a solute or hydrophobic natural product in the extraction solvent.

Suitable extraction columns with stationary internals can include, but are not limited to, those that contain either structured or random packing, perforated plates, baffle trays, sieve trays, spray columns, and combinations thereof. Suitable packings include structured or random packings that are known to those skilled in the art. Suitable mechanically agitated extraction columns can include, but are not limited to, the Karr reciprocating plate column, the York Scheibel column, and the rotating disc column, all made by Koch Modular Process Technology Corporation, which is located in Paramus, N.J.; the Kuhni column, which is sold by Sulzer in Switzerland; the asymmetric rotating disc column, pulsed columns, and combinations thereof.

Suitable centrifugal extractors that can be used as the first contacting unit include, but are not limited to those produced by CINC, Alfa Lavel, Podbielniak, Robatel, Westfalia, and combinations of these centrifugal extractors. Other suitable centrifugal extractors include but are not limited to those manufactured by GEA Westfalia Separator GmbH, which is headquartered in Oelde, Germany; Alfa Laval, with a location in Richmond, Virginia; Robatel, which is located in Pittsfield, Massachusetts; and Podbielniak, which is manufactured by Baker Perkins of Saginaw, Michigan.

Suitable emulsion phase contactors that can be used as the first contacting unit include, but are not limited to, those produced by Schlumberger termed the NATCO dual frequency electrostatic treater.

The liquid-liquid-extraction process (100) depicted in FIG. 1 further shows the first contacting unit (104) receiving a feed stream from a source (102) and a first solvent. Once the first solvent has been received by the first contacting unit (104), the first solvent contacts the feed stream received by the first contacting unit (104), thereby forming a first dispersion.

The first solvent is any solvent that, upon contacting and/or during contacting with the feed stream, is capable of separating the first dispersion into at least a two-layer extraction system, wherein at least one layer rapidly settles.

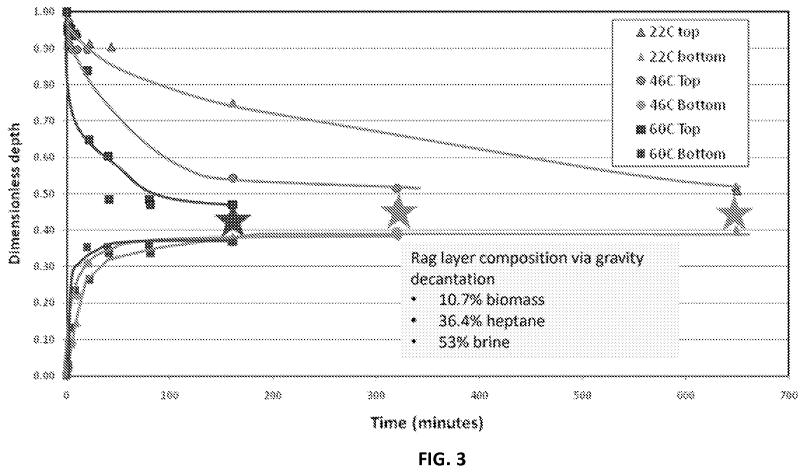

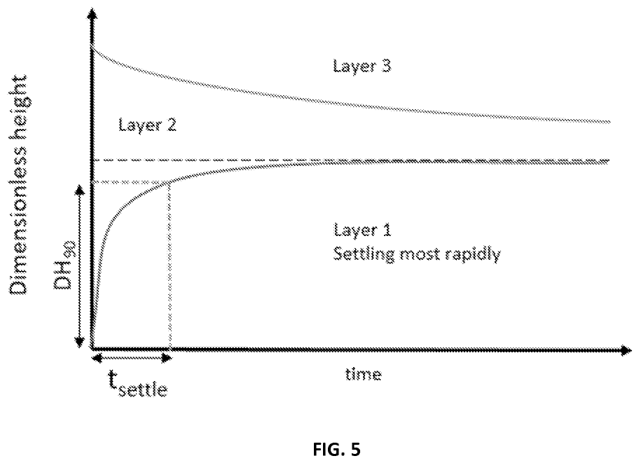

A layer that “rapidly settles” is one that reaches 90% of a dimensionless height asymptote within about 30 minutes or less on a decantation curve as shown in FIG. 3 or FIG. 5 and has a dimensionless height 90 (DH90) ratio of the fast separating layer to the slow separating layer of less than 0.8. A DH90 ratio is the ratio of the settling time for the rapidly settling layer at DH90 to the settling time for the slowest settling layer at DH90.

It has been surprisingly discovered that by changing the operating parameters to enhance the settling of one layer and separating at least a portion of the settled layer from the two-layer extraction system, efficient liquid-liquid-solid extraction processes can be performed with reduced process equipment volume.

An additional surprising discovery is that when the two conditions for the rapidly settling layer are satisfied, i.e., reaching 90% of a dimensionless height asymptote within about 30 minutes or less and a DH90 ratio of less than 0.8, at least the first contacting unit can be any extraction equipment used in liquid-liquid extraction processes. Liquid-liquid-solid extractions are typically performed in mixer-settler units, wherein the settler is 10 times the size of the mixer. Thus, the settler size in these units sets the economic burden on those liquid-liquid-solid extraction processes.

Initially, when phase separation begins the dispersion is uniform and there are no interfaces. However, as settling occurs, two or more layers begin to form. The layers are regions with clear differences physically and/or optically to adjacent regions. The depth of these layers is measured as dimensionless height, DH. The DH is computed by dividing the depth of the layer of interest by the total depth of the liquid-liquid-solid dispersion so that the DH ranges from zero to unity. The DH for each layer is recorded over the entire settling time on a decantation curve until the dimensionless depth of the layers change less than about 1% over a three hour time increment, where the last recorded DH value is defined as the asymptotic value of the asymptote to the decantation depth for said layer, also called the dimensionless depth asymptote. The DH90 value for a layer is defined as the settling time when the DH of said layer reached 90% of the asymptotic value. The DH90 value can be determined for each layer. In an exemplary embodiment, the DH90 ratio is the ratio of the settling time for the most rapidly settling layer at DH90 to the settling time for the slowest settling layer at DH90. For an example, see FIG. 5.

Through the use of the liquid-liquid-solid extraction processes disclosed herein, mixer-settler units containing smaller settler units can be used. The ability to perform the liquid-liquid-solid extraction processes disclosed herein with mixer-settler units containing smaller settler units is attractive at least from an economic viewpoint since capital cost and solvent hold-up issues would decrease when compared to liquid-liquid-solid extraction processes employing conventional mixer-settler units, wherein the settler is 10 times the size of the mixer.

The first solvent can be an extraction solvent including, but are not limited to, a non-polar solvent, a non-polar organic solvent, a dense gas solvent, an aqueous two-phase solvent, an ionic liquid, a light solvent, a light organic solvent, or a combination thereof. In an exemplary embodiment the first solvent is a light solvent, a light organic solvent, a dense gas solvent, an aqueous two-phase solvent, an ionic liquid and/or any combination thereof. In an exemplary embodiment the first solvent can comprise or be a deep eutectic solvent (DES) and/or a natural deep eutectic solvent (NADES) (such as choline chloride, glucose, lactic acid, malic acid, and/or any combination thereof). The first solvent can also be a mixture of miscible solvents. The first solvent is chosen such that it can form an immiscible liquid phase with the feed stream and it has a density that differs from the feed stream. Thus, the optimal extraction solvent for the liquid-liquid-solid extraction process can depend on which natural products are desired to be extracted from the feed stream.

The expression “light solvent” refers to a solvent that forms a liquid phase that floats on top of the other liquid phases during the phase separations and is in contact with the vapor phase. The expression “heavy solvent” refers to a solvent that forms a heavy liquid phase that collects at the bottom of a settler and is typically in contact with the bottom of the tank or vessel, and/or is just above an even heavier solid phase. The “dense gas solvent” has been defined above.

The expression “phase separation” refers to the creation of two or more distinct phases from a single heterogeneous mixture. When a dispersion or mixture is allowed to phase separate, it is meant that a significant portion of the droplets in both the heavy and light liquid phases have coalesced so that the liquid-liquid interfacial area between these two liquid phases is approaching a minimum, which in a gravity decanter is the cross-sectional area of the vessel that is perpendicular to the gravitational field. For example, in a gravity decanter, a single heterogeneous mixture with a dispersed heavy phase is fed to the decanter. There is sufficient time in the decanter to allow droplets of the heavy phase to settle through the light liquid phase where they build up and coalesce in order to build or form a separate heavy liquid phase at the bottom of the light liquid phase. As this heavy liquid phase grows, smaller and smaller heavy phase droplets fall through the light liquid phase following Stokes Law and build up a region where there are many heavy phase droplets that have accumulated. In this region, droplets of the heavy phase continue to coalescence until essentially all of the droplets have coalesced and their heavy phase liquid contents have joined the bulk of the continuous heavy liquid phase region that has formed below the light liquid phase. In some cases, extremely small droplets may not have coalesced, but their volume is a small single digit percentage of the total volume of the heavy phase. Likewise, as the heavy phase forms, some of the light liquid phase may be entrained in the rapidly coalescing heavy phase droplets, and form droplets of the light liquid phase in the heavy phase. These droplets of the light liquid phase rise through the heavy continuous phase, and must coalesce in order for the contents of the light phase droplets to rejoin the continuous light liquid phase above the liquid-liquid interface. In the case when there are solids present, they may accumulate at the liquid-liquid interface. If they accumulate at the liquid-liquid interface, they can hinder the coalescence of the droplets and cause an emulsion to form. This is generally termed a rag layer, and this is not a true thermodynamic phase, but is a region that contains the solid particles, and both the light and heavy liquid phases. The use of the term “phase” refers to a true thermodynamic phase as described in this paragraph, whereas the term “layer” refers to a region with clear differences physically and/or optically to adjacent regions.

In exemplary embodiments, the first solvent is a solvent system that forms a two-layer extraction system with the feed stream. These solvent systems should not adversely impact the quality or quantity of the natural products. These solvent systems can include synthetic and/or natural flavorants, edible oils, petrochemicals, bio-based chemicals, dense gases, and combinations of these so long as the mixture of the solvent system and the feed stream form two immiscible phases. The solvent system can also include petrochemical solvents due to their low viscosity and favorable solute molecular diffusivity. Natural oils are soluble in petrochemical solvents and concentrated extracts are possible. Suitable petrochemical solvents can include those that are disclosed in “Organic Solvents: Physical Properties and Methods of Purification”, edited by J. A. Riddick et al., Volume 2, Fourth Edition, ISBN Number 0-471-08467-0. The petrochemical solvents can include, but are not limited to, aliphatic hydrocarbons (such as pentane, hexane, heptane, octane, nonane, decane, dodecane, cyclohexane, petroleum ether, their isomers, and mixtures thereof), aromatic hydrocarbons (including but not limited to benzene, toluene, xylene), alcohols (including, but not limited to butanol, pentanol, hexanol, octanol, dodecanol, cyclohexanol, benzyl alcohol, their isomers, and combinations thereof), ketones (including, but not limited to methyl isobutyl ketone, hexanone, heptanone, octanone, their isomers, and combinations thereof), esters (including, but not limited to methyl acetate, ethyl acetate, propyl acetate, butyl acetate, pentyl acetate, hexyl acetate, ethyl propionate, ethyl butyrate, ethyl valerate, their isomers, and combinations thereof). Combinations of petrochemical solvents may also be used if desired.

The petrochemical solvents can also contain one or more co-solvents. Examples of these co-solvents include methanol, ethanol, 1-propanol, 2-propanol, 1-hexanol, 2-methoxy ethanol, acetone, tetrahydrofuran, 1,4-dioxane, acetonitrile, dichloromethane, chloroform, dimethyl sulfoxide, formic acid, carbon disulfide, methylene chloride, amines, chelating agents, phase transfer catalysts and combinations thereof. The co-solvents can also be added to the feed stream to enhance recovery of solutes or hydrophobic natural products.

Suitable bio-based solvents include, but are not limited to, any of those listed in the petrochemical solvents, except the fact that they are derived from biological sources that are recently grown such as 2-methyloxolanase.

The edible oils which can be included within the solvent system can be chosen from those obtained from plant or animal sources, such as fish oils. Edible vegetable oil solvents include, but are not limited to, those derived from corn, olive, algae, soybean, flax, safflower, sunflower, palm, jatropha, coconut, other oils known in the art, and combinations thereof. Compared to petrochemical solvents, edible oils can be more viscous, and the solute molecular diffusivity is lower.

The solvent system can also include synthetic and natural flavorants. These flavorants can be more desirable than petrochemical solvents and edible oils if the natural products are to be used for human or animal consumption. Naturally derived flavorants have appeal in nutritional supplements. Flavorants classified by the Flavor and Extract Manufacturers Association, or FEMA, as Generally Recognized As Safe, or GRAS, do not have the drawbacks of petrochemical solvents in association with nutritional supplements. The presence of residual flavorant solvents in nutritional supplements is generally acceptable in comparison with petrochemical solvents, which reduces downstream purification and recovery costs. The flavorants can be chosen from those which have boiling points, viscosities, and molecular diffusivity properties comparable to petrochemical solvents. Examples of such flavorants include, but are not limited to, methyl-, ethyl-, propyl-, butyl-, isobutyl-, benzyl-, and octyl-esters with the carboxylic acid component of the ester including acetate, ethanoate, propionate, butyrate, hexanoate, caproate, heptanoate, octanoate, decanoate, cinnamate, and isovalerate. Other examples of flavorants which can be used include, but are not limited to, benzaldehyde, other aldehydes, limonene, and other terpenes. Combinations of flavorants may also be used, if desired.

Suitable dense gases which can be used as the first solvent include, but are not limited to, carbon dioxide, ethane, propane, butane, chlorofluorocarbons, and mixtures thereof. A dense gas extraction can be operated in any manner known in the art including leaching, batch extraction, and continuous countercurrent extraction as described in U.S. Pat. Nos. 6,106,720 and 5,932,101, the contents of which are incorporated herein by reference in their entirety. Additional suitable dense gases can be methane, isobutane, dimethyl ether, sulfur hexafluoride, ammonia, fluorocarbons, and mixtures thereof. Any combination of the above dense gases can also be used.

The dense gases can also contain one or more co-solvents to improve extractability of solutes. Examples of these co-solvents include methanol, ethanol, 1-propanol, 2-propanol, 1-hexanol, 2-methoxy ethanol, acetone, tetrahydrofuran, 1,4-dioxane, acetonitrile, dichloromethane, chloroform, dimethyl sulfoxide, formic acid, carbon disulfide, methylene chloride, amines, chelating agents, phase transfer catalysts and combinations thereof. Other examples of dense gases and co-solvents are listed in U.S. Pat. Nos. 4,345,976 and 5,490,884, the contents of which are incorporated herein by reference in their entirety. The co-solvents can also be added to the feed stream to enhance recovery of a solute or hydrophobic natural products.

The solvent system can also include an ionic liquid. Suitable ionic liquids include, but are not limited to, solvent systems that are at least in the liquid phase at the temperature of the contacting in the first contacting unit, those that contain a cation and an anion, and those that are immiscible with a water-rich algal concentrate phase.

The first solvent can be a hydrocarbon, ester, ketone, acetate, dense gas, and other solvents identified by J. A. Riddick et al., (1986) [Organic Solvents: Physical Properties and Methods of Purification, 4th Edition, ISBN 0-471-08467-0].

In exemplary embodiments, the contacting of the feed stream and the first solvent in the first contacting unit occurs under a solvent to feed stream ratio (e.g., a volumetric ratio) from about 9 to about 0.1, from about 5 to about 0.2, or of 1 (e.g., a 1 to 1 volumetric ratio).

In exemplary embodiments, the contacting of the feed stream and the first solvent in the first contacting unit occurs for about 1 minute to 30 minutes, for about 5 minutes to 10 minutes, or any amount of time under 15 minutes. The contacting time can differ based on the type of first contacting unit used and the extraction kinetics to extract the desired solute from the solid matrix. For example, when the first contacting unit is a centrifugal extractor, the contact time may range from about 0.5 to 10 minutes, or less than 2 minutes. When an agitated vessel is used for the first contacting unit, the contact time may range from about 1 minute to 10 minutes. The feed stream can contact the first solvent for about 2 to 15 minutes, about 5 to 10 minutes or about 10 to 15 minutes in a counter-current extraction column. Also, for example, when the extraction kinetics of the solute from the solid matrix is rapid relative to the interfacial mass transfer kinetics, then the contact time may range in the various contacting equipment as just described. However, if the extraction kinetics are slow relative to the interfacial mass transfer kinetics, then the required contact time may be longer than just described.

In exemplary embodiments, the contacting of the feed stream and the first solvent in the first contacting unit can be an intimate contact.

An “intimate contact” relates to a mixing of the feed stream and the first solvent to where an acceptable interfacial mass transfer of the components in the feed stream and first solvent is achieved. An acceptable interfacial mass transfer can be achieved when the two immiscible liquid phases are completely dispersed in the liquid-liquid-solid dispersion. Thus, droplets of the dispersed liquid phase are dispersed throughout the continuous liquid phase, and a separate immiscible liquid phase or solid phase is not present at either the top or the bottom of the agitated vessel during the intimate contact.

The term “first dispersion” relates to a heterogeneous mixture containing at least a portion of the feed stream and at least a portion of the first solvent along with the biomass.

The liquid-liquid-solid extraction process (100) depicted in FIG. 1 further shows the first dispersion formed in the first contacting unit (104) being transferred to a first separating unit (106). Once the first dispersion is received by the first separating unit (106), the first dispersion is allowed to phase separate into a first separated liquid phase and a first remaining dispersion. At least a portion of the first separated liquid phase is removed and thus separated for the rest of the process from the first remaining dispersion.

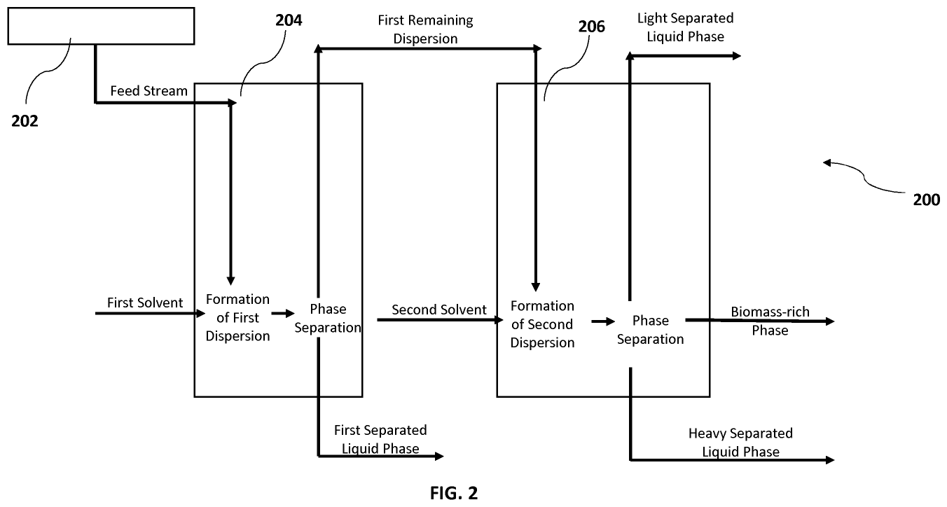

In exemplary embodiments, the separation of the first dispersion into the first separated liquid phase and the first remaining dispersion does not occur in the first separating unit and instead occurs within the first contacting unit, as illustrated in FIG. 2. In these embodiments the first separating unit can be optional. An example of this embodiment is when a counter-current extraction column is used as the first contacting unit.

The first separating unit can include, but is not limited to, a decanter, a coalescer, a centrifuge, an electrically enhanced decanter, a hydroclone or combinations thereof.

The first contacting unit and the first separating unit can be combined in, for example, a batch-operating mixer-settler, counter-current extraction column, a centrifugal extractor, or other methods known in the art, and combinations thereof.

In exemplary embodiments, the first separating unit includes or is a decanter which is configured to perform at least one or more of gravity settling, centrifugal settling, and/or combinations thereof to separate the first dispersion into the first separated liquid phase and the first remaining dispersion. In exemplary embodiments, the first separating unit includes one or more fixed or moving separation aids, for example, mesh pad coalescers, wire pad coalescers, structured packing, inclined plates, perforated plates, baffles, ultrasonic waves, acoustic waves, and/or combinations thereof.

The allowing of the first dispersion to phase separate into the first separated liquid phase and the first remaining dispersion can occur for about 1 minute to 30 minutes, 5 minutes to 15 minutes, 1 minute to 5 minutes, 5 minutes to 10 minutes, or any amount of time under 15 minutes.

In exemplary embodiments, the first separated liquid phase and the first remaining dispersion do not phase separate in less than 30 minutes under gravitational acceleration, i.e. the first separated liquid phase and the first remaining require at least 30 minutes under gravitational acceleration to phase separate.

The allowing of the first dispersion to phase separate into the first separated liquid phase and the first remaining dispersion can be performed at ambient conditions so that the temperature can range from 5 to 90° C. and the pressure can be atmospheric. In exemplary embodiments, the allowing of the first dispersion to phase separate into the first separated liquid phase and the first remaining dispersion is performed at room temperature. In other exemplary embodiments, the allowing of the first dispersion to phase separate into the first separated liquid phase and the first remaining dispersion is performed at 70° C.

In exemplary embodiments, the allowing of the first dispersion to phase separate into the first separated liquid phase and the first remaining dispersion includes retaining the feed stream in the first separating unit for a set period of time until the first separated liquid phase and the first remaining dispersion form, i.e. until phase separation of the first separated liquid phase and the first remaining dispersion has taken place. The set period of time can be any time from 1 minute to 30 minutes, 2 minutes to 15 minutes, 5 minutes to 15 minutes, 1 minute to 5 minutes, 5 minutes to 10 minutes, or any amount of time under 15 minutes.

In exemplary embodiments, at least 50 wt %, at least 60 wt %, at least 70 wt %, at least 80 wt %, at least 90 wt % or any amount from 50 wt % to 99 wt % of the first separated liquid phase is removed and thus separated from the first remaining dispersion.

In exemplary embodiments, the first separated liquid phase contains a higher concentration of the aqueous solution originating from the feed stream than the first remaining dispersion. The first separated liquid phase can contain up to 50 wt %, up to 60 wt %, up to 70 wt %, up to 80 wt %, up to 90 wt % or any amount from 50 wt % to 99 wt % of the aqueous solution relative to the total wt % of the first separated liquid phase.

In exemplary embodiments, the first separated liquid phase reaches 90% of a dimensionless height asymptote within about 30 minutes ((settle)<30 min) during the forming, i.e. phase separation of the first separated liquid phase and the first remaining dispersion from the first dispersion.

In exemplary embodiments, the first separated liquid phase and the first remaining dispersion have a settling time ratio at DH90 of about 0.8 or less.

In exemplary embodiments, the allowing of the first dispersion to phase separate into the first separated liquid phase and the first remaining dispersion includes maintaining a first solvent to feed stream ratio of about 0.1 to 10 and/or a flux of about 10 m³/h/m² to 80 m³/h/m².

In an exemplary embodiment, the allowing of the first dispersion to phase separate into the first separated liquid phase and the first remaining dispersion include maintaining a first solvent to feed stream ratio of about 0.1 to 10.

In exemplary embodiments, the allowing of the first dispersion to phase separate into the first separated liquid phase and the first remaining dispersion occurs in the first contacting unit.

In exemplary embodiments, the removing of the first separated liquid phase from the first remaining dispersion can include transferring the first separated liquid phase from the first separating unit and/or the first contacting unit to a first separated liquid phase processing unit. The first separated liquid phase processing unit can include, but is not limited to, crystallization ponds, polishing ponds and/or combinations thereof. In these embodiments, at least a portion of the first remaining dispersion remains in the first separating unit and/or the first contacting unit.

The liquid-liquid-solid-extraction process (100) depicted in FIG. 1 further shows the first remaining dispersion formed in the first separating unit (106) being transferred to a second contacting unit (108). Once the first remaining dispersion is received by the second contacting unit (108), a second solvent is introduced into the second contacting unit (108) and contacts the first remaining dispersion to form a second dispersion.

In exemplary embodiments, the method includes transferring the first remaining dispersion to at least one auxiliary contacting unit and/or separating unit before the contacting the first remaining dispersion with the second solvent in the second contacting unit; or transferring the second dispersion to at least one auxiliary contacting unit and/or separating unit before the second dispersion is phase separated into the biomass-rich phase, the heavy separated liquid phase and the light separated liquid phase. The method may thus include transferring the first remaining dispersion to at least one auxiliary contacting unit and/or separating unit before the first remaining dispersion is transferred to the second contacting unit. For example, the first remaining dispersion can be transferred to at least one, at least two, at least three, at least four, at least five, at least six, at least seven, at least eight, at least nine, or at least ten or more auxiliary contacting units and/or separating units before being transferred to the second contacting unit.

In exemplary embodiments, the first remaining dispersion is contacted with the first solvent in one or more auxiliary contacting units.

The second contacting unit can include, but is not limited to, any of the mixer-settlers, counter-current extraction columns, centrifugal extractors, membrane extractors, extractors that employ non-standard contact methods (e.g., extractors that use electrical fields, ultrasonic waves, and/or microwave waves to aid in the extraction of materials) and combinations thereof that the first contacting unit can include. In exemplary embodiments, the second contacting unit contains at least one different extraction equipment from the first contacting unit.

The second solvent is any solvent that can form the second dispersion upon and/or during contact with the first remaining dispersion. In exemplary embodiments, the second solvent is the same as the first solvent in order to reduce the complexity of the solvent recovery system. In other exemplary embodiments, the second solvent differs from the first solvent in order to facilitate better phase separation of the remaining layers. In other exemplary embodiments, the second solvent differs from the first solvent in order to facilitate recovery of a different solute from the system.

In exemplary embodiments, the second solvent is a solvent that has a density that is at least about 0.05 g/cm³ less than the density of the first separated liquid phase.

In exemplary embodiments, the second solvent is a solvent that has an apparent viscosity that is at least about 1 mPa/s less than the viscosity of the first separated liquid phase, when the apparent viscosity is optionally measured according to ISO 2884-1:1999.

The second solvent can be an extraction solvent including, but not limited to, a non-polar solvent, a non-polar organic solvent, a dense gas solvent, an aqueous two-phase solvent, an ionic liquid or a combination thereof. The second solvent can also be a mixture of miscible solvents. In an exemplary embodiment the second solvent can comprise or be a deep eutectic solvent (DES) and/or a natural deep eutectic solvent (NADES) (such as choline chloride, glucose, lactic acid, malic acid, and/or any combination thereof).

The second solvent can include any solvent or solvent mixture that can be included in the first solvent. In exemplary embodiments, the second solvent is the first solvent.

In an exemplary embodiment, a second solvent to feed stream ratio or a second solvent to first remaining dispersion ratio is about 0.1 to 10. In an exemplary embodiment, a first solvent to feed stream ratio is about 0.1 to 10 and a second solvent to feed stream (or to first remaining dispersion) ratio is about 0.1 to 0.10.

The operating conditions of the second contacting and second separating unit can differ significantly from the operating conditions of the first contacting and first separating unit. In exemplary embodiments, the temperature of the first and second contacting and separating units differ. In other exemplary embodiments, the pH and/or the salinity of the first and second contacting and separating units differ. In other exemplary embodiments, the pressure of the first and second contacting and separating units differ. In other exemplary embodiments, the equipment types used for the first and second contacting and separating units differ. Other exemplary embodiments have the gravitational acceleration used in the first and second contacting and separating units that differ. These differences between the first and second contacting and separating units can result from the removal of the first separated liquid phase. In one embodiment, the salinity of the heavy separated liquid phase is greater than about 5, 10, 15, or 20 wt % salt.

The term “second dispersion” relates to the heterogeneous mixture containing at least a portion of the first remaining dispersion and at least a portion of the second solvent. The second dispersion can have a higher concentration of biomass than the first dispersion. Therefore, different methods of handling the second dispersion than those deployed to handle the first dispersion can be necessary.

In exemplary embodiments, the contacting between the first remaining dispersion and the second solvent in the second contacting unit can occur from 1 minute to about 60 minutes, but additional time may be required if the leaching kinetics are slow relative to the interfacial mass transfer kinetics.

The liquid-liquid-solid-extraction process (100) depicted in FIG. 1 further shows the second dispersion formed in the second contacting unit (108) being transferred to a second separating unit (110). Once the second dispersion is received by the second separating unit (110), the second dispersion is allowed to phase separate into a biomass-rich phase, a heavy separated liquid phase and a light separated liquid phase. The biomass-rich phase, the heavy separated liquid phase and the light separated liquid phase are then separated from the second separating unit (110) for output as recovered products or for further downstream processing.

In exemplary embodiments, the method includes transferring the second dispersion to at least one other auxiliary contacting unit and/or separating unit before the second dispersion is transferred to the second separating unit. For example, the second dispersion can be transferred to at least one, at least two, at least three, at least four, at least five, at least six, at least seven, at least eight, at least nine, or at least ten or more auxiliary contacting units and/or separating units before being transferred to the second separating unit.

In exemplary embodiments, the second dispersion is contacted with the second solvent in one or more auxiliary contacting units.

In exemplary embodiments, the method includes adding the first solvent, the second solvent and/or any other solvent to any of the auxiliary contacting and/or separating units.

In exemplary embodiments, the phase separation of the second dispersion into the biomass-rich phase, the heavy separated liquid phase and the light separated liquid phase occurs in the second contacting unit. In these embodiments, the second separating unit can be optional.

In the second contacting unit or the second separating unit, the second dispersion can be contacted with the second solvent. The hydrophobic algal components or algal oil in the second dispersion are transferred from the second dispersion into the extraction solvent (i.e., the second solvent). The second dispersion then separates into multiple phases. One phase can be depleted of hydrophobic algal components and contain the aqueous solution originating from the feed stream (i.e., the heavy separated liquid phase). Algal biomass can collect at a fluid-fluid interface, and this material is a component of the biomass-rich phase or layer. The biomass-rich phase can also include salt-laden lipid-depleted algal biomass as well as limited amounts of the heavy separated liquid phase. Thus, two immiscible fluid phases, the heavy separated liquid phase and the light separated liquid phase, and a biomass-rich phase can be formed. Either of the two immiscible fluid phases can be made the continuous phase. The biomass-rich phase of algal biomass is formed between the light separated liquid phase, which includes lipids, carotenoids, and the extraction solvent, and the heavy separated liquid phase, which is rich in water and salts and usually contains trace amounts of lipids and carotenoids. The algal biomass of the biomass-rich phase can be rich in chlorophyll, glycerol, phospholipids, and proteins and can be either discarded or subjected to processing to recover these components.

The phase separation of the second dispersion can be performed at ambient conditions so that the temperature and pressure can range from 5 to about 100° C., e.g. 5 to 90° C., and the pressure is atmospheric. The phase separation can be performed at much higher temperatures. Bloch et al. in U.S. Pat. No. 4,341,038 teach that phase separation processes can be operated at temperatures to 300° C., to obtain certain results. The phase separation can operate at a temperature below 100° C. to preserve the algal oils and carotenoids. Likewise, the pressure can be increased for the use of supercritical fluids. U.S. Pat. No. 6,106,720 teaches the advantages of high-pressure phase separations.

The second separating unit can include, but is not limited to, a decanter, a coalescer, a centrifuge, an electrically enhanced decanter, a hydrocyclone or combinations thereof.

The first contacting unit and the first separating unit can be combined in, for example, a batch-operating mixer-settler, counter-current extraction column, a centrifugal extractor, or other methods known in the art, and combinations thereof.

The second contacting unit and the second separating unit can be combined in, for example, a batch-operating mixer-settler, counter-current extraction column, a centrifugal extractor, or other methods known in the art, and combinations thereof.

In exemplary embodiments, the second separating unit includes or is a decanter which is configured to perform at least one or more of gravity settling, centrifugal settling, and/or combinations thereof to separate the second dispersion into the biomass-rich phase, the heavy separated liquid phase and the light separated liquid phase. In exemplary embodiments, the second separating unit includes one or more fixed or moving separation aids, for example, mesh pad coalescers, wire pad coalescers, structured packing, inclined plates, perforated plates, baffles, ultrasonic waves, acoustic waves, and/or combinations thereof.

In exemplary embodiments, the method includes reducing the total extraction volume of the first, second and/or auxiliary contacting units and separating units. In exemplary embodiments, the total extraction volume is reduced by more than 20%, or by more than 40%, when compared to the total extraction volume of a single contacting and separating unit.

In exemplary embodiments, the second dispersion is allowed a specified period of time to phase separate into the biomass-rich phase, the heavy separated liquid phase and the light separated liquid phase. The specified period of time can be from at least 10 minutes to about 24 hours, at least 20 minutes to 12 hours, at least 30 minutes to 6 hours, or 40 minutes to 3 hours.

The term “biomass-rich phase” relates to a fluid layer or phase that includes a majority of the biomass originating from the feed stream and may also include at least a portion of the heavy separated liquid phase and at least a portion of the light separated liquid phase.

The biomass-rich phase can form at any location between, above or below the heavy separated liquid phase and the light separated liquid phase. In exemplary embodiments, the biomass-rich phase forms between the heavy separated liquid phase and the light separated liquid phase.

In exemplary embodiments, the biomass-rich phase forms below the light separated liquid phase.

The biomass-rich phase can include a lipid-depleted biomass. The lipid-depleted biomass can include at least one or more of chlorophyll, glycerol, phospholipids, proteins, carbohydrates, fibers, and limited amounts of lipids, carotenoids and/or salts relative to the second dispersion or any combination thereof.

In exemplary embodiments, the biomass-rich phase composition contains about 10 wt % biomass, about 45 wt % of light separated liquid phase and about 45 wt % of the heavy separated liquid phase.

In exemplary embodiments, the biomass-rich phase contains at least 50 wt %, at least 60 wt %, at least 70 wt %, at least 80 wt %, at least 90 wt % or any amount from 50 wt % to 99 wt % of biomass. The biomass present in the biomass-rich phase can include lipid-depleted biomass. The amount of lipid-depleted biomass in the biomass-rich phase can be at most 10 wt %, at most 20 wt %, at most 30 wt %, at most 40 wt %, at most 50 wt %, at most 60 wt %, at most 70 wt %, at most 80 wt %, at most 90 wt % or any amount from 50 wt % to 99 wt % of the total weight of the biomass-rich phase.

The term “heavy separated liquid phase” relates to a phase or layer that is composed mostly of water or saltwater and may contain at least a portion of the biomass-rich layer and at least a portion of the second solvent used to create the second dispersion. In exemplary embodiments, less than 10%, 20%, 30% of the biomass-rich layer is entrained in the heavy separated liquid phase.

The heavy separated liquid phase can include an aqueous salt solution depleted of hydrophobic natural products.

The heavy separated liquid phase and/or the first separated liquid phase can possess a salt concentration of above 5 wt %, above 7 wt %, above 10 wt % above 15 wt %, above 18 wt %, or up to saturation. In exemplary embodiments a salinity of the heavy separated liquid phase and/or the first separated liquid phase is about 5 wt % or greater than 5 wt %, about 6 wt % or greater than 6 wt %, about 7 wt % or greater than 7 wt %, for example at least about 8 wt %, at least about 9 wt %, at least about 10 wt %, at least about 11 wt %, at least about 12 wt %, at least about 13 wt %, at least about 14 wt %, at least about 15 wt %, at least about 16 wt %, at least about 17 wt %, at least about 18 wt %, at least about 19 wt %, at least about 20 wt %, at least about 21 wt %, at least about 22 wt %, at least about 23 wt %, at least about 24 wt %, or at least about 25 wt %. In other exemplary embodiments, the heavy separated liquid phase and/or the first separated liquid phase is saturated with salt, e.g., contains a salt concentration of at least 26.5 wt %. In exemplary embodiments, the heavy separated liquid phase and/or the first separated liquid phase can have a salinity that is about 5 wt % to about saturation, from about 10 wt % to saturation, from about 20 wt % to saturation, from about 5 wt % to about 20 wt %, from about 10 wt % to about 20 wt %, from about 5 wt % to about 15 wt %, from about 10 wt % to about 15 wt %, or from about 5 wt % to about 10 wt %.

In exemplary embodiments, the heavy separated liquid phase includes an aqueous salt solution and a polar organic solvent, for example, methanol, dimethyl sulfoxide, or dimethylformamide.

The term “light separated liquid phase” relates to a phase or layer that is composed mostly of a solvent and contains at least one hydrophobic natural product originating from the biomass of the feed stream.

The first solvent can include or be the same solvent that is used as the second solvent. The second solvent can also include a portion of the first solvent.

The light separated liquid phase may also contain at least a portion of the biomass-rich layer.

The expression “natural product” refers to products which are naturally produced or found within an environment, a living organism or a biomass. Natural products can include those which are hydrophobic, hydrophilic or amphipathic.

In exemplary embodiments, the natural products are those which are naturally produced by a plant, a microbe, an algae or microalgae species which can be included within the feed stream and/or the biomass. These natural products can include, but are not limited to, lipids, algal lipids, carotenoids, fatty acids, algal fatty acids, triacylglycerols, diacylglycerols, monoacylglycerols, oils, algal oils, chlorophyll, glycerol, phospholipids, carbohydrates, fibers, and proteins.

The light separated liquid phase can include at least one hydrophobic natural product. These hydrophobic natural products can include, but are not limited to, lipids, algal lipids, carotenoids, fatty acids, algal fatty acids, triacylglycerols, diacylglycerols, monoacylglycerols, oils, algal oils and combinations thereof.

The carotenoids can include beta-carotene, alpha-carotene, lutein, zeaxanthin, beta-cryptoxanthin, astaxanthin, phytoene, phytofluene, lycopene, and/or combinations thereof.

The light separated liquid phase can also include limited amounts of lipid-depleted biomass and the aqueous salt solution.

In exemplary embodiments, the separating of at least one or more of the biomass-rich phase, the heavy separated liquid phase, and/or the light separated liquid phase for output as recovered products includes removing at least one or more of the biomass-rich phase, the heavy separated liquid phase, and/or the light separated liquid phase from the second contacting unit and/or the second separating unit.

According to an embodiment, the allowing of the first dispersion to phase separate into the first separated liquid phase and the first remaining dispersion and/or the allowing of the second dispersion to phase separate into the biomass-rich phase, the heavy separated liquid phase and the light separated liquid phase occurs under a gravitational field.

The separation of the biomass-rich phase, the heavy separated liquid phase and the light separated liquid phase can be carried out or performed under a gravitational field.

The separation of the biomass-rich phase, the heavy separated liquid phase and the light separated liquid phase can occur or can be performed at a pressure ranging from atmospheric to supercritical conditions for the light solvent.

In exemplary embodiments, the liquid-liquid-solid extraction process can include recovering products from at least one or more of the separated biomass-rich phase, the separated heavy separated liquid phase, and/or the separated light separated liquid phase, the products including at least one of lipids, algal lipids, carotenoids, fatty acids, algal fatty acids, triacylglycerols, diacylglycerols, monoacylglycerols, oils, algal oils and any combination thereof.

In exemplary embodiments, the liquid-liquid-solid extraction process can include performing a temperature and/or pressure adjustment before the feed stream contacts the first solvent in the first contacting unit, before the first solvent enters the first contacting unit, during the contacting of the feed stream with the first solvent in the first contacting unit and/or any combination thereof.

In exemplary embodiments, the liquid-liquid-solid extraction process is a multi-stage process. A “multistage” liquid-liquid-solid extraction process is one wherein at least the first contacting unit, the first separating unit, the second contacting unit, the second separating unit and/or any combination thereof is at least duplicated to achieve the liquid-liquid-solid extraction processes disclosed herein.

In exemplary embodiments, the liquid-liquid-solid extraction process includes outputting at least one or more of the biomass-rich phase, the heavy separated liquid phase, and/or the light separated liquid phase as recovered products or a feed for downstream processing units.

In exemplary embodiments, the phase separation of the first dispersion into the first separated liquid phase and the first remaining dispersion is carried out or performed under a gravitational field.

In exemplary embodiments, the phase separation of the first dispersion into the first separated liquid phase and the first remaining dispersion is carried out or performed at a pressure ranging from atmospheric to supercritical conditions for the first solvent.

In exemplary embodiments, the contacting of the feed stream with the first solvent in the first contacting unit is carried out or performed under a gravitational field.

In exemplary embodiments, the contacting of the feed stream with the first solvent in the first contacting unit is carried out or performed at a pressure ranging from atmospheric to supercritical conditions for the first solvent.

In exemplary embodiments, the contacting of the first remaining dispersion with the second solvent in the second contacting unit is carried out or performed under a gravitational field.

In exemplary embodiments, the contacting of the first remaining dispersion with the second solvent in the second contacting unit is carried out or performed at a pressure ranging from atmospheric to supercritical conditions for the second solvent.

In exemplary embodiments, the allowing of the second dispersion to phase separate into the biomass-rich phase, the heavy separated liquid phase and the light separated liquid phase is carried out or performed under a gravitational field.

In exemplary embodiments, the allowing of the second dispersion to phase separate into the biomass-rich phase, the heavy separated liquid phase and the light separated liquid phase is carried out or performed at a pressure ranging from atmospheric to supercritical conditions for the second solvent, such as the light solvent.

In exemplary embodiments, the liquid-liquid-solid-extraction process includes removing at least one of the biomass-rich phase, the heavy separated liquid phase and/or the light separated liquid phase from the second contacting unit or second separating unit and outputting the at least one biomass-rich phase, heavy separated liquid phase and/or light separated liquid phase as a recovered product to a downstream processing unit configured to recover products from the at least one biomass-rich phase, heavy separated liquid phase and/or light separated liquid phase.

In exemplary embodiments, at least a portion of the light separated liquid phase is overflowed or pumped out of the second contacting unit or second separating unit, the biomass-rich phase is pumped out of the second contacting unit or second separating unit and/or the heavy separated liquid phase is removed from the bottom of the second contacting unit or second separating unit.

The downstream processing unit can include, but is not limited to, a means to filter the outputted biomass-rich phase, heavy separated liquid phase and/or light separated liquid phase; a means to evaporate the outputted biomass-rich phase, heavy separated liquid phase and/or light separated liquid phase; a means to pelletize the outputted biomass-rich phase, heavy separated liquid phase and/or light separated liquid phase; a means to recycle the outputted biomass-rich phase, heavy separated liquid phase and/or light separated liquid phase or any combination thereof.

The present process may thus comprise at least one or more of filtering the biomass-rich phase after separating from the heavy separated liquid phase and the light separated liquid phase to remove any entrained solvent and/or hydrophobic natural products; filtering the light separated liquid phase after separating from the biomass-rich phase and the heavy separated liquid phase to recover any entrained biomass; and/or filtering the heavy separated liquid phase after separating from the biomass-rich phase and the light separated liquid phase to remove any entrained solvent and/or any entrained biomass.

In exemplary embodiments, the outputted light separated liquid phase is contacted with an aqueous phase to remove any residual salt concentrations that may be present within the light separated liquid phase.

In exemplary embodiments, the outputted light separated liquid phase is filtered to remove and/or recover any entrained biomass in the light separated liquid phase.

In exemplary embodiments, the outputted biomass-rich phase is filtered to remove and/or recover any entrained solvent and/or hydrophobic natural products in the biomass-rich phase.

In exemplary embodiments, the outputted heavy separated liquid phase is filtered to remove and/or recover any entrained solvent, hydrophobic natural products and/or biomass in the heavy separated liquid phase.

In exemplary embodiments, the outputted light separated liquid phase undergoes an evaporation process in an evaporator to remove at least a portion of the second solvent.

In exemplary embodiments, the outputted light separated liquid phase contains the first and/or second solvent and undergoes an evaporation process in an evaporator to remove at least a portion of the first and/or second solvent.

In exemplary embodiments, the outputted light separated liquid phase contains the first and/or second solvent and undergoes a distillation process in a multistage distillation tower to separate the first and second solvents for recycle to the process.

In exemplary embodiments, the light separated liquid phase contains the first solvent and the liquid-liquid-solid extraction process includes evaporating the first solvent from the light separated liquid phase after separating the light separated liquid phase from the heavy separated liquid phase and the biomass-rich phase.

In exemplary embodiments, the outputted biomass-rich phase is transferred to a pelletizer to pelletize the biomass material in the biomass-rich layer.

In exemplary embodiments, the outputted biomass-rich phase and/or outputted heavy separated liquid phase is recycled back to the feed stream source.

In exemplary embodiments, the liquid-liquid-solid extraction process is configured as a continuous process wherein the receiving of the feed stream from the source, the contacting of the feed stream with the first solvent in the first contacting unit to form the first dispersion, the allowing of the first dispersion to phase separate into the first separated liquid phase and the first remaining dispersion, the removing of at least a portion of the first separated liquid phase, the contacting of the first remaining dispersion with the second solvent in the second contacting unit to form the second dispersion, the allowing of the second dispersion to phase separate into the biomass-rich phase, the heavy separated liquid phase and the light separated liquid phase, and the recovering of the at least one or more biomass-rich phase, heavy separated liquid phase, and/or light separated liquid phase for output as products are performed sequentially. Continuous operation can allow for the production of biofuels and/or other hydrophobic natural products with reduced capital and operating costs.

A variety of extraction equipment components can be used for continuous extraction including: mixers and settlers, countercurrent extraction columns, centrifugal extractors, and other classes of extractors known in the art as described by Pratt et al., Selection, Design, PilotTesting, and Scale-Up of Extraction Equipment, Chapter 8, in Science and Practice of LiquidLiquid Extraction, Volume 1, Clarendon Press, Oxford, 1992, the contents of which are incorporated herein by reference in their entirety.

Suitable centrifugal extractors can include, but are not limited to, those manufactured by GEA Westfalia Separator GmbH, which is headquartered in Oelde, Germany; Alfa Laval, with a location in Richmond, Virginia; Robatel, which is located in Pittsfield, Massachusetts; and Podbelniak, which is manufactured by Baker Perkins of Saginaw, Michigan.

Suitable other extraction equipment includes, but is not limited to hollow fiber membrane extractors and other extractor designs known in the art. In some cases, hollow fiber membrane extractors are used since they obviate the need to separate the solvent from the algal biomass.

Gravity settling is useful in a continuous extraction process. Separation of the multiple phases that form throughout the liquid-liquid-solid extraction processes disclosed herein can be achieved in a centrifugal or gravitational force field, but gravity settling is usually of lower cost. A coalescer may be added to assist in the formation of the first and/or second dispersion. The heavy separated liquid phase can be coalesced to recover any additional first solvent, second solvent and/or light solvent that may be entrained within the heavy separated liquid phase before the heavy separated liquid phase is recycled to a bioreactor or returned to a pond, depending on the type of aquaculture practiced. A coalescer, liquid/liquid/solid centrifuge, and liquid/liquid cyclone can be used to recover solvents from the heavy separated liquid phase, or the heavy separated liquid phase can be recycled for cleanup.

Suitable materials for the construction of the mixer, decanter, and/or extraction equipment include, but are not limited to, non-ferrous materials, plastics, fiberglass, fiberglass reinforced plastics such as fiberglass reinforced HDPE, and combinations thereof. Non-ferrous materials are advantageous due to the possible salt contents of the feed stream and the heavy separated liquid phase formed from the extraction processes. The salinity of these components could cause stress corrosion cracking in ferrous materials, thereby greatly increasing the maintenance required on the mixer, decanter, and extraction equipment. Plastic and fiberglass equipment is resistant to the effects of the elevated salinity and may be less expensive than equipment constructed of ferrous material. However, various alloys can be used for the mixer, decanter, and/or extraction equipment. Suitable alloys can be those that bring corrosion rates to an acceptable level. Suitable alloys may include, but are not limited to carbon steel, stainless steels, duplex steels, Hastelloys, as well as glass and glass lined equipment, and combinations thereof.

The light separated liquid phase, the heavy separated liquid phase, the biomass-rich phase or a combination thereof can be stabilized against degradation by any of the following means including, but not limited to, the addition of antioxidants; storage of the material in the absence of light exposure; storage under an inert environment such as nitrogen, argon, or carbon dioxide; and subjecting the material to a thermal cycle to destroy bacteria. Suitable antioxidants include, but are not limited to carotenoids, tertiary butyl hydroquinone (TBHQ), butylated hydroxyanisole (BHA), butylated hydroxytoluene (BHT), vitamin E, vitamin C, rosemary extracts, and combinations thereof.

Suitable mixers for the extraction zone include agitated vessels where a mechanical agitator is used to intimately contact the feedstock stream and the extraction solvent. The mechanical agitator can include one or more impellers on a rotating shaft. Suitable impellers include, but are not limited to Rushton Turbines, flat-blade turbines, pitch-blade turbines, marine propellers, hydrofoils, impellers that are sold by Chemineer (Dayton Ohio), or SPX/Lightnin (Rochester, New York). Regardless of the type of impeller used, the degree of agitation required is important for efficient mass transfer of the solute. The degree of agitation required can be calculated by the minimum impeller speed to completely disperse one immiscible liquid in another, as defined by Skelland and Ramsay [1987 I&EC Res. 26, 1, 77-81], Skelland and Moeti [1989, I&EC Res. 28, 1, 122-127] and Skelland and Kanel [1993, I&EC Res. 29, 7, 1300-1306]. Static mixers of any design can also be used as the extraction zone. Suitable static mixers include, but are not limited to, those produced by Chemineer in their Kenics line.

Suitable extraction columns which can be used as the extraction zone include, but are not limited to, those that are mechanically agitated and those that have stationary internals. The latter is preferred when the extraction solvent is a dense gas and/or the operating pressure of the extractor is elevated so that more expensive mechanical seals are needed. Suitable extraction columns with stationary internals can include, but are not limited to, packed, perforated plate, baffle tray, and combinations thereof. Suitable packings include structured or random packings that are known to those skilled in the art. Suitable mechanically agitated extraction columns can include, but are not limited to, the Karr reciprocating plate column, the York Scheibel column, and the rotating disc column, all made by Koch Modular Process Technology Corporation, which is located in Paramus, N.J., the Kuhni column, which is sold by Sulzer in Switzerland, the asymmetric rotating disc column, pulsed columns, and combinations thereof.

In exemplary embodiments, the first contacting unit and the first separating unit are combined into and/or are part of a single extraction unit, e.g., a countercurrent column.

In exemplary embodiments, second contacting unit and the second separating unit are combined into and/or are part of a single extraction unit, e.g., a countercurrent column.

In exemplary embodiments, the first contacting unit and the second contacting unit are countercurrent extraction columns, wherein the contacting of the feed stream with the first solvent to form the first dispersion and the allowing of the first dispersion to phase separate into the first separated liquid phase and the first remaining dispersion occur in the first contacting unit, and wherein the contacting of the first remaining dispersion with the second solvent to form the second dispersion and the allowing of the second dispersion to phase separate into the biomass-rich phase, the heavy separated liquid phase and the separated light separated liquid phase occur in the second contacting unit.

FIG. 2 depicts an exemplary embodiment wherein the liquid-liquid-solid extraction (200) is performed with countercurrent extraction columns, one being a first countercurrent contacting unit (204) and the other being a second countercurrent contacting unit (206). In this embodiment, a feed stream originating from a feed source (202) is received by the first countercurrent contacting unit (204). The feed stream is more dense than the first solvent so it travels downward in the first countercurrent contacting unit (204) and intimately contacts the first solvent as it rises through the first countercurrent contacting unit. The first solvent is introduced into the bottom of the first countercurrent contacting unit (204). The contact between the first solvent and the feed stream forms a first dispersion in the first countercurrent contacting unit (204).

This first dispersion is allowed to phase separate into a first remaining dispersion and a first separated liquid phase in the disengagement portion of the extraction column. At least a portion of the first separated liquid phase is removed from the bottom of the first countercurrent contacting unit (204). The first remaining dispersion is also removed from the first countercurrent contacting unit (204) and transferred to the second countercurrent contacting unit (206).

At least a part of the first remaining dispersion travels downward in the second countercurrent contacting unit (206) where it intimately contacts the second solvent that is being introduced into the bottom of the second countercurrent contacting unit (206). A second dispersion is formed from the contact between the first remaining dispersion and the second solvent in the second countercurrent contacting unit (206).

The second dispersion is allowed to phase separate in the disengagement section of the second countercurrent contacting unit (206) into a light separated liquid phase, a biomass-rich phase and a heavy separated liquid phase. The light separated liquid phase is separated from the other phases and removed from the top of the second countercurrent extraction column contacting unit (206). The biomass-rich layer is separated from the other phases and removed from the second countercurrent extraction column contacting unit (206) at a point between the top and bottom of the second countercurrent extraction column contacting unit (206). The heavy separated liquid phase is separated from the other phases and removed from the bottom of the second countercurrent extraction column contacting unit (206).

In exemplary embodiments, the liquid-liquid-solid extraction process includes repeating the contacting of the feed stream with the first solvent, or another solvent, in the first contacting unit to form the first dispersion and/or repeating the allowing of the first dispersion to phase separate into the first separated liquid phase and the first remaining dispersion in the first separating unit before the first remaining dispersion is transferred to the second contacting unit and/or any auxiliary contacting or separating unit.

Systems for performing the liquid-liquid-solid extraction processes described herein are also disclosed. These systems are designed for recovering products from a feed stream containing biomass in an aqueous salt solution and include the following components: a feed stream import line; a first contacting unit in communication with the feed stream import line; a first solvent import line in communication with the first contacting unit; a first effluent export line in communication with the first contacting unit; a second contacting unit in communication with the first contacting unit through the first effluent export line; a second solvent import line in communication with the second contacting unit; and a first extraction line in communication with the second contacting unit.

The system may also be defined as a system configured for recovering products from a feed stream containing biomass is disclosed herein, the system including the following components: a feed stream import line configured for delivering the feed stream to a first contacting unit; a first contacting unit configured for receiving the feed stream from the feed stream import line and a first solvent from a first solvent import line, the first contacting unit including (i) a first means configured for separating the feed stream into a first separated liquid phase and a first remaining dispersion, (ii) a second means configured for removing at least a portion of the first separated liquid phase from the first remaining dispersion and (iii) a third means configured for transferring the first remaining dispersion to a second contacting unit; a second contacting unit including (a) a fourth means configured for separating the first remaining dispersion into a biomass-rich phase, a heavy separated liquid phase and a light separated liquid phase and (b) a fifth means configured for removing at least one or more of the biomass-rich phase, the heavy separated liquid phase and the light separated liquid phase from the second contacting unit.

In exemplary embodiments, the system is designed such that its total extraction volume is reduced by more than 20%, or more than 40%, by adding the second contacting and separating units at the same decantation efficiency of the light and/or heavy phases compared to a single stage system.

The expression “light phase” refers to the liquid phase that floats on top of the other liquid phases during the phase separations and is in contact with the vapor phase. The expression “heavy phase” refers to the heavy liquid phase that collects at the bottom of a settler and is in contact with the bottom of the tank or vessel, and/or is just above an even heavier solid phase.

The expression “total extraction volume” means the combined volume of contacting unit(s) and separating unit(s).

The expression “decantation efficiency” refers to the percentage of approach to a dimensionless height asymptote.

In exemplary embodiments, the first contacting unit and/or the second contacting unit include at least one or more of a mixer-settler unit, a counter-current extraction column, a co-current extraction column, a centrifugal extractor, membrane extractors, an emulsion phase contactor, any extractor that relies upon non-standard contact methods and/or any combination thereof.

In exemplary embodiments, the feed stream import line, the first solvent import line, the first effluent export line, the second solvent import line and/or the first extraction line is a pipe, a tube or a canal.

In exemplary embodiments, the system includes a second extraction line in communication with the second contacting unit; and a third extraction line in communication with the second contacting unit.

In exemplary embodiments, the first extraction line is configured to remove a light separated liquid phase from the second contacting unit, the second extraction line is configured to remove a biomass-rich phase from the second contacting unit, and the third extraction line is configured to remove a heavy separated liquid phase from the second contacting unit.

In exemplary embodiments, the first contacting unit and the second contacting unit are each at least one counter-current extraction columns.

In exemplary embodiments, the system includes a first separating unit in communication with the first contacting unit and the second contacting unit. In exemplary embodiments, the system includes a first transport line in communication with the first contacting unit and the first separating unit. The first transport line can be a pipe, a tube or a canal.

In exemplary embodiments, the system includes a second separating unit in communication with the second contacting unit and at least one or more of the first extraction line, the second extraction line, the third extraction line and/or any combination thereof. In exemplary embodiments, the system includes a second transport line in communication with the second contacting unit and the second separating unit. The second transport line can be a pipe, a tube or a canal.

In exemplary embodiments, the first contacting unit and the first separating unit are part of a single extraction unit, e.g., a countercurrent extraction column.

In exemplary embodiments, the second contacting unit and the second separating unit are part of a single extraction unit, e.g., a countercurrent extraction column.

In exemplary embodiments, the system includes more than two contacting unit and/or separating units. For example, the system can include at least three, four, five, six, seven, eight, nine, ten or more auxiliary contacting units; and at least three, four, five, six, seven, eight, nine, ten or more auxiliary separating units. These additional auxiliary contacting and separating units can include any of the extraction equipment that the first contacting unit, the first separating unit, the second contacting unit and the second separating unit can have. These additional auxiliary contacting and separating units can be separate units from each other and/or can be part of a single extraction unit, e.g., a countercurrent extraction column.

In exemplary embodiments, the first extraction line is configured to remove a light separated liquid phase from the second separating unit, the second extraction line is configured to remove a biomass-rich phase from the second separating unit, and the third extraction line is configured to remove a heavy separated liquid phase from the second separating unit.

Systems configured to perform the liquid-liquid-solid extraction processes described herein are also disclosed. These systems are configured for recovering products from a feed stream containing biomass in an aqueous salt solution and can include one or more of the following components: a feed stream import line configured for delivering the feed stream to a first contacting unit, wherein the first contacting unit is configured for receiving the feed stream from the feed stream import line and a first solvent from a first solvent import line, the first contacting unit including: a first means configured for separating the feed stream into a first separated liquid phase and a first remaining dispersion, a second means configured for removing at least a portion of the first separated liquid phase from the first remaining dispersion, and a third means configured for transferring the first remaining dispersion to a second contacting unit, wherein the second contacting unit includes: a fourth means configured for separating the first remaining dispersion into a biomass-rich phase, a heavy separated liquid phase and a light separated liquid phase and a fifth means configured for removing at least one or more of the biomass-rich phase, the heavy separated liquid phase and the light separated liquid phase from the second contacting unit.

In exemplary embodiments, the first means and/or the fourth means is at least one or more of a mixer-settler unit, a counter-current extraction column, a co-current extraction column, a centrifugal extractor, membrane extractors, an emulsion phase contactor, any extractor that relies upon non-standard contact methods and/or any combination thereof.

In exemplary embodiments, the first means and/or the fourth means include any separating unit disclosed herein.

In exemplary embodiments, the second means is a first effluent export line in communication with the first contacting unit.

In exemplary embodiments, the third means is a first stream forward line in communication with the first contacting unit and the second contacting unit.

In exemplary embodiments, the fifth means is at least one extraction line in communication with the second contacting unit.

In exemplary embodiments, the fifth means includes at least one or more of a first extraction line configured to remove a light separated liquid phase from the second contacting unit, a second extraction line configured to remove a biomass-rich phase from the second contacting unit, and a third extraction line configured to remove a heavy separated liquid phase from the second contacting unit.

In exemplary embodiments, the fourth means is in communication with a second solvent import line configured to introduce a second solvent into the second contacting unit.

In exemplary embodiments, the fourth means includes a second separating unit, and the fifth means includes at least one or more of a first extraction line configured to remove a light separated liquid phase from the second separating unit, a second extraction line configured to remove a biomass-rich phase from the second separating unit, and a third extraction line configured to remove a heavy separated liquid phase from the second separating unit.

In exemplary embodiments, the feed stream import line, the first solvent import line, the second means, the third means, the fifth means and/or any combination thereof is a pipe, a tube or a canal.

In exemplary embodiments, the system includes more than two contacting units configured to perform the liquid-liquid-solid extraction processes described herein. For example, the system can include at least three, four, five, six, seven, eight, nine, ten or more auxiliary contacting units possessing any of the first means, second means, third means and/or fourth means discussed herein.

According to an embodiment of the system, the first means and/or the fourth means is at least one or more of a mixer-settler unit, a counter-current extraction column, a co-current extraction column, a centrifugal extractor, membrane extractors, an emulsion phase contactor, any extractor that relies upon non-standard contact methods and/or any combination thereof; the second means is a first effluent export line in communication with the first contacting unit; the third means is a first stream forward line in communication with the first contacting unit and the second contacting unit; and the fifth means is at least one extraction line in communication with the second contacting unit; wherein the fourth means is in communication with a second solvent import line configured to introduce a second solvent into the second contacting unit.

Methods for designing a liquid-liquid-solid extraction process for recovering products from a feed stream comprising biomass in an aqueous solution are also disclosed. These methods can include intimately contacting a feed stream and a first extraction solvent and measuring the decantation curves, similar to those as shown in FIG. 3, that form upon and/or during contact. If the time required to reach 90% of the dimensionless height asymptote is greater than about 30 minutes for one or both of the interfaces that form upon and/or during contact, then the feed stream and the first extraction solvent should preferably be intimately contacted at elevated temperatures at the maximum temperature that is possible to achieve before the products are degraded and/or before the temperature exceeds the design parameters of the equipment. These methods can also include selecting the phase with the shortest time to reach 90% of the dimensionless height asymptote, i.e., the one that separates most rapidly to form a cleaner phase, and removing a desired amount of that phase from the first separating unit before passing the first remaining dispersion to the second contacting unit. These methods can also include intimately contacting the first remaining dispersion with the second extraction solvent and determining the impact of various independent variables on the decantation curves formed upon or during contact in the second contacting unit. These methods can also include selecting operating parameters for the second contacting unit and the second separating unit to optimize the overall extraction costs. Generally, after intimately contacting the phases in either the first or second contacting units, one of the liquid phases will be clear and the 90% dimensionless height asymptote will be reached within about 30 minutes and the other phase will take a longer time to reach the 90% dimensionless height asymptote. In exemplary embodiments, the ratio of the 90% dimensionless height asymptote ratio for the fast to the slow decanting phase will be less than about 0.8.

In exemplary embodiments, the intimately contacting of the feed stream and the first extraction solvent occurs at any temperature from 5° C. to 90° C.

In exemplary embodiments, the desired amount of the phase with the shortest time to reach 90% of the dimensionless height asymptote removed from the first separating unit is any amount ranging from 50 wt % to 99.9 wt % of the total weight of the phase with the shortest time to reach 90% of the dimensionless height asymptote in the first separating unit.

The separation of the three-layer systems has been difficult to accomplish, and this has forced companies to use dry extraction processes. In dry extraction processes, the biomass is separated from the aqueous solution by drying prior to charging it to the extraction zone. The drying step is expensive and requires significant energy input. The liquid-liquid-solid extraction processes disclosed herein not only overcome some of the challenges of efficiently extracting natural products from a biomass, they also provide liquid-liquid-solid extraction processes that can be efficiently performed under a gravitational field. This can significantly reduce the capital and energy costs of performing an extraction process.

It is further surprising that a majority of hydrophobic natural products can be removed from the biomass and transferred into the solvent extract layer in an amount of time that renders this step economically attractive. If the concentration of biomass in an extractor feed is properly selected, the extraction equipment used can be any that is commonly used in liquid-liquid or liquid-liquid-solid extraction processes.

Exemplary advantages of the liquid-liquid-solid extraction processes disclosed herein include, but are not limited to, not needing to dry the biomass in the feed stream prior to extracting the hydrophobic natural products from the biomass, not needing to desalt the biomass prior to extracting the hydrophobic natural products from the biomass, not needing to handle solids in the extraction process and thus not needing to consider the associated dust explosion hazards, and being able to employ traditional liquid-liquid extraction equipment instead of expensive leaching equipment and large mixer-settler units, thus saving costs on processing equipment and components, for example, solvents.

Any of a variety of products can be made from the biomass or lipid-depleted biomass recovered from the extraction processes disclosed herein including, but not limited to, biofuels, nutraceuticals, cosmeceuticals, wastewater treatment processes, spa products, animal feeds, human food, soil builders, chemical intermediates, specialty lipids, solar salt, and combinations thereof.

Biofuels that may be produced from high temperature processing of the biomass or lipid-depleted biomass include, but are not limited to, biodiesel, green diesel, renewable diesel, methane, alcohols, and dried algal biomass. Algal biodiesel is produced via any transesterification process known in the art, including those which utilize two immiscible liquid phases, and those that utilize a solid acid catalyst. Green diesel may be produced by hydrogenation, cracking, or a combination thereof of the algal oil or any derivative thereof in order to produce hydrocarbons that can be used directly in the existing diesel distribution system. Methane and/or hydrogen may be produced from the biomass or lipid-depleted biomass by any anaerobic process known in the art. Fermentation of the biomass or lipid-depleted biomass by any process known in the art may be used to produce methanol, ethanol, butanol, n-butanol, i-butanol, other alcohols, and combinations thereof. The biomass or lipid-depleted biomass may be torrefied for the production of a soil builder or for use in combination with coal for power or steam generation. The biomass or lipid-depleted biomass may be dried and then gasified or combusted either by itself or in combination with coal or biomass.

The biomass or lipid-depleted biomass may be extracted to recover the lipids that can be used as an animal feed ingredient, renewable plastics, renewable polymers, renewable chemicals, nutraceuticals, cosmeceuticals, soaps or components of a soap or detergent compositions, and cosmetic ingredients, including, but not limited to carotenoids, omega fatty acids, and other lipids. For the production of solar salt, the biomass may be removed from solar salt works in order to improve the salt quality. The quality of sodium chloride, sodium carbonate, and other salts can be improved by this method. Biomass or lipid-depleted biomass stabilized with the high temperature treatment process may also be used in animal nutrition, especially for shrimp and fish aquaculture diets. The biomass or lipid-depleted biomass may also be treated with the high temperature process to stabilize it against degradation during transportation. Alternatively, high temperature processing could be used to stabilize the biomass or lipid-depleted biomass prior to its storage for carbon sequestration purposes. The biomass may be used to derive valuable chemical intermediates such as fatty acids for the production of polyurethanes.

Suitable animal feeds include, but are not limited to, feeds for shrimp, fish, shellfish, brine shrimp, chickens, poultry, cows, ducks, dogs, pigs, sheep, goats, and combinations thereof. The animal feeds may require the stabilized biomass to be dried, but in some cases, for example for use in shrimp and fish aquaculture diets, complete drying may not be necessary as long as stabilization is sufficient.

Suitable dietary supplements include, but are not limited to alpha carotene, betacarotene, lutein, zeaxanthin, cryptoxanthin, phytoene, phytofluene, and the various cis- and trans-isomers and the various alpha, beta, gamma, delta isomers of the various carotenoids, and combinations thereof.

Suitable methods of carbon storage include, but are not limited to, burying the biomass or lipid-depleted biomass, sinking it, torrefying it and using it as a soil builder, or combinations thereof.

Suitable methods for water and wastewater treatment include, but are not limited to, removal of BOD (biological oxygen demand), and/or TOC (total organic carbon) from a water stream. This may be useful for municipal wastewater treatment processes, and it may be important for the treatment of brines being used for the production of sodium chloride salt and other salts via evaporation.

Suitable methods to process the biomass or lipid-depleted biomass into useful compounds include but are not limited to torrefaction, gasification, liquefaction, fermentation, drying, combustion, burial, and combinations thereof. Suitable applications of the torrefied biomass include, but are not limited to, a soil builder and a material to be combined with coal, wood, or other combustible material for power generation. Suitable applications of gasified biomass include, but are not limited to, the production of the entire suite of products that can be produced via syngas chemistry, as described by the Gasification Technologies Council. Suitable products from syngas include, but are not limited to, chemicals, fertilizers, power generation, substitute natural gas, hydrogen, and transportation fuels. Suitable chemicals include, but are not limited to, hydrogen, carbon monoxide, methanol, dimethyl ether, acetic acid, propionic acid, butyric acid, acetic anhydride, methyl acetate, ethylene, propylene, olefins, and combinations thereof. Suitable fertilizers that can be produced from the syngas include, but are not limited to ammonia, ammonium nitrate, urea, and others known in the art. Suitable substitute natural gas can be generated from the syngas produced by gasifying algal biomass or lipid-depleted biomass, and this includes methane. Suitable liquid fuels include gasoline, diesel fuel, jet fuels, and combinations thereof. All of the chemicals that are produced by Eastman Chemicals and by Sasol via their gasification processes may also be produced by the gasification of biomass or lipid-depleted biomass. Products produced by the utilization of syngas may also be produced by gasification of biomass. Illustrative processes are described in U.S. Pat. No. 6,310,260, the contents of which are incorporated herein by reference in their entirety, which include, for example, hydroformylation, hydroacylation (intramolecular and intermolecular), hydrocyanation, hydroamidation, hydroesterification, aminolysis, alcoholysis, hydrocarbonylation, reductive hydroformylation, hydrogenation, olefin oligomerization, hydroxycarbonylation, carbonylation, olefin isomerization, transfer hydrogenation and the like. Other processes involve the reaction of organic compounds with carbon monoxide, or with carbon monoxide and a third reactant, e.g., hydrogen, or with hydrogen cyanide, in the presence of a catalytic amount of a metal-organophosphorus ligand complex catalyst. More advantageous processes include hydroformylation, hydrocyanation, hydrocarbonylation, hydroxycarbonylation and carbonylation.

Use of a system of the present disclosure is disclosed herein for recovering products from a feed stream containing biomass. Also, a system of the present disclosure can be used for carrying out a process of the present disclosure.

The present description relates also to a method for designing a liquid-liquid-solid extraction process for recovering products from a feed stream containing biomass, the method comprising intimately contacting the feed stream and a first extraction solvent, optionally at a temperature from 5° C. to 90° C., in a first contacting unit and measuring the decantation curves that form upon and/or during contact in a first separating unit, in which the first dispersion phase separates into a first separated liquid phase and a first remaining dispersion; selecting a phase with the shortest time to reach 90% of a dimensionless height asymptote and removing a desired amount of said phase from the first separating unit before passing a first remaining dispersion to a second contacting unit; intimately contacting the first remaining dispersion with a second solvent and determining the decantation curves formed upon and/or during contact in the second contacting unit, in which second dispersion phase separates into a biomass-rich phase, a heavy separated liquid phase and a light separated liquid phase; and selecting operating parameters for the second contacting unit and a second separating unit to optimize the overall extraction costs of the method.

### EXAMPLES

The present disclosure will be described in more detail with reference to the following Examples, which shows exemplary embodiments in accordance with the present disclosure. The present disclosure is not limited to these exemplary embodiments.

### Example 1

A feed stream including water, salt, algal biomass, and algal oil was fed to the top of a first extraction column at a temperature of 70° C. The objective of this process was to separate the aqueous phase from algal oil, carotenoids and the algal biomass. A first solvent stream including heptane was fed to the bottom of the first extraction column, and this stream was heated to 70° C. The solvent to feed ratio was maintained at 0.2 with a flux of 24.5 m³/h/m². The aqueous phase was maintained as the continuous phase. The first raffinate (i.e., first separated liquid phase) included primarily water and salt. The ratio of the algal biomass concentration in the first raffinate to the feed stream was reduced to 0.15. The remainder of the algal biomass along with the solvent phase (i.e., first remaining dispersion) including heptane, algal oil and carotenoids was removed as the first extract stream. The first extract stream was in turn fed to the top of a second extraction column at 70° C. A second solvent stream including heptane was fed to the bottom of the second extractor at 70° C. The ratio of the cross-sectional area of the second extraction column to the first extraction column was 0.25. The solvent to feed ratio was maintained at 0.5 with a flux of 14.3 m³/h/m². The solvent phase was maintained as the continuous phase. The second raffinate (i.e., second dispersion) included an emulsion of water, salt, algal biomass and solvent phase. The second extract (i.e., light separated liquid phase) included the algal oil, carotenoids, and solvent wherein the ratio of soluble carotenoids in the second extract stream to the first extract stream was greater than 1.1. By configuring the two-step extraction in this configuration, the second extraction column was significantly reduced in size relative to the first extraction column.

### Example 2

The objective of this process was to separate the aqueous phase from algal oil, carotenoids and the algal biomass. A feed stream including water, salt, algal biomass, carotenoids, and algal oil was fed to the top of a first extraction column, and it was preheated to a temperature of 70° C. A first solvent stream including heptane was fed to the bottom of the first extraction column, and this stream was heated to 70° C. The solvent to feed ratio was maintained at 0.4 with a flux of 20.4 m³/h/m². The aqueous phase was maintained as the continuous phase. The first raffinate (i.e., first separated liquid phase) included primarily water and salt. The ratio of the algal biomass concentration in the first raffinate to the feed stream was reduced to 0.18. The remainder of the algal biomass along with the solvent phase (i.e., first remaining dispersion) including heptane, algal oil and carotenoids was removed as the first extract stream. The first extract stream was in turn fed to the top of a second extraction column at 70° C. A second solvent stream including heptane was fed to the bottom of the second extractor at 70° C. The ratio of the cross-sectional area of the second extraction column to the first extraction column was 0.25. The solvent to feed ratio was maintained at 0.25 with a flux of 40.7 m³/h/m². The solvent phase was maintained as the continuous phase. The second raffinate (i.e., second dispersion) included a dispersion of water, salt, algal biomass and solvent phase. The second extract (i.e., light separated liquid phase) included the algal oil, carotenoids, and solvent wherein the ratio of carotenoids in the second extract stream to the first extract stream was greater than 1.2. By configuring the two-step extraction in this configuration, the second extraction column was reduced in size relative to the first extraction column because a significant amount of the water and salt from the feed was removed in the first raffinate stream. This allowed the cross-sectional area of the second extraction column to be 25% of the cross-sectional area of the first extraction column.

### Example 3

The objective of this process was to separate the aqueous phase from algal oil, carotenoids and the algal biomass. A feed stream including water, salt, algal biomass, carotenoids, and algal oil was fed to the top of a first extraction column, and it was preheated to a temperature of 70° C. A first solvent stream including heptane was fed to the bottom of the first extraction column, and this stream was heated to 70° C. The solvent to feed ratio was maintained at 0.6 with a flux of 20.4 m³/h/m². The aqueous phase was maintained as the continuous phase. The first raffinate (i.e., first separated liquid phase) included primarily water and salt. The ratio of the algal biomass concentration in the first raffinate to the feed stream was reduced to 0.10. The remainder of the algal biomass along with the solvent phase (i.e., first remaining dispersion) including heptane, algal oil and carotenoids was removed as the first extract stream. The first extract stream was in turn fed to the top of a second extraction column at 70° C. A second solvent stream including heptane was fed to the bottom of the second extractor at 70° C. The ratio of the cross-sectional area of the second extraction column to the first extraction column was 0.25. The solvent to feed ratio was maintained at 0.25 with a flux of 40.7 m³/h/m². The solvent phase was maintained as the continuous phase. The second raffinate (i.e., second dispersion) included a dispersion of water, salt, algal biomass and solvent phase. The second extract (i.e., light separated liquid phase) included the algal oil, carotenoids, and solvent wherein the ratio of carotenoids in the second extract stream to the first extract stream was greater than 1.2. By configuring the two-step extraction in this configuration, the second extraction column was reduced in size relative to the first extraction column because a significant amount of the water and salt from the feed was removed in the first raffinate stream. This allowed the cross-sectional area of the second extraction column to be 25% of the cross-sectional area of the first extraction column.

### Example 4: Batch Extraction of Oil from Algae at 22° C.

Saltwater containing about 2 wt % D. salina (termed the “feed”) was intimately contacted for five minutes with heptane (“solvent”) in an agitated vessel held at 22° C. The feed to solvent volumetric ratio was about 1:1. The liquid-liquid-solid dispersion was then placed into a vertical decantation vessel with straight vertical walls to allow the phases to settle by gravity. The decantation vessel was jacketed to maintain a constant temperature of the dispersion during the decantation process. Three distinct phases (or layers) separated in the decanter: 1) an extract phase (i.e., light separated liquid phase) at the top, 2) a biomass-rich phase in the middle, and 3) a raffinate phase (i.e., heavy separated liquid phase) at the bottom. Between these three phases, two interfaces were formed. An upper interface formed between the clear extract phase and the opaque biomass-rich phase. A lower interface also formed between a clear raffinate phase and the opaque biomass-rich phase. The location of these two interfaces was observed through sight glasses and recorded as a function of decantation time. The interface locations were converted into dimensionless depths by dividing the interface location distance from the bottom of the vessel by the total liquid depth in the decantation vessel. The location of these two interfaces allowed the decantation kinetics to be visually tracked, and the data are shown by squares in FIG. 3. The extract phase separated very slowly, as the upper interface took more than 600 minutes to approach within 90% the final dimensionless depth. The raffinate phase separated more quickly, as the lower interface took less than 100 minutes to approach 90% of the final dimensionless depth. Thus, the mean residence time for the extraction/decantation of the total dispersion in the mixer and settler to achieve 90% of the phase separation was 605 minutes when operated in batch mode.

### Example 5: Continuous Extraction of Oil from Algae at 22° C.

The batch results from Example 4 were used to compute the mean residence time for a mixer-settler operating in a continuous flow mode. In this process, both feed and solvent are continuously and steadily added to the mixer portion of a mixer-settler. The mean contact time between these phases in the agitated vessel are held constant at five minutes to allow for proper interfacial mass transfer. The dispersion is transferred to a gravity decanter, each phase is only retained by the amount of time necessary to allow 90% of that phase to be removed from the decanter as a pure (clear) phase. The mean residence time of the raffinate and extract phases are then chosen to be 100 and 600 minutes, respectively, based on data from FIG. 3. The mean residence time for the extract phase in the continuous flow decanter is 600 minutes for 35% of the volumetric flow. The mean residence time for the raffinate phase in the continuous flow decanter is 100 minutes for the other 35% of the volumetric flow. Combined the total mean residence time of the continuous flow system is 5+390+35, or 420 minutes. Thus, the volume of the continuous-flow mixer-settler system is reduced by 30% when compared to the batch mode.

### Example 6: Batch Extraction of Oil from Algae at 46° C.

Saltwater containing about 2 wt % D. salina (termed the “feed”) was intimately contacted for five minutes with heptane (“solvent”) in an agitated vessel held at 46° C. The feed to solvent volumetric ratio was about 1:1. The liquid-liquid-solid dispersion was then placed into a vertical decantation vessel with straight vertical walls to allow the phases to settle by gravity. The decantation vessel was jacketed to maintain a constant temperature of the dispersion during the decantation process. Three distinct phases (or layers) separated in the decanter: 1) an extract phase (i.e., light separated liquid phase) at the top, 2) a biomass-rich phase in the middle, and 3) a raffinate phase (i.e., heavy separated liquid phase) at the bottom. Between these three phases, two interfaces were formed. An upper interface formed between the clear extract phase and the opaque biomass-rich phase. A lower interface also formed between a clear raffinate phase and the opaque biomass-rich phase. The location of these two interfaces was observed through sight glasses and recorded as a function of decantation time. The interface locations were converted into dimensionless depths by dividing the interface location distance from the bottom of the vessel by the total liquid depth in the decantation vessel. The location of these two interfaces allowed the decantation kinetics to be visually tracked, and the data are shown by squares in FIG. 3. The extract phase separated very slowly, as the upper interface took more than 150 minutes to approach 90% of the final dimensionless depth. The raffinate phase separated more quickly, as the lower interface took less than 50 minutes to approach 90% of the final dimensionless depth. Thus, the mean residence time for the extraction/decantation of the total dispersion in the mixer and settler to achieve 90% of the phase separation was 205 minutes when operated in batch mode.

### Example 7: Continuous Extraction of Oil from Algae at 46° C.

The batch results from Example 6 were used to compute the mean residence time for a mixer-settler operating in a continuous flow mode. In this process, both feed and solvent are continuously and steadily added to the mixer portion of a mixer-settler. The mean contact time between these phases in the agitated vessel is held constant at five minutes to allow for proper interfacial mass transfer. The dispersion is transferred to a gravity decanter, each phase is only retained by the amount of time necessary to allow 90% of that phase to be removed from the decanter as a pure (clear) phase. The mean residence time of the raffinate and extract phases are then chosen to be 50 and 150 minutes, respectively. The mean residence time for the extract phase in the continuous flow decanter is 150 minutes for 35% of the volumetric flow. The mean residence time for the raffinate phase in the continuous flow decanter is 50 minutes for the other 35% of the volumetric flow. Combined the total mean residence time of the continuous flow system is 5+53+18, or 75 minutes. Thus, the volume of the continuous-flow mixer-settler system is reduced by 60%, when compared to the batch mode.

### Example 8: Batch Extraction of Oil from Algae at 60° C.

Saltwater containing about 2 wt % D. salina (termed the “feed”) was intimately contacted for five minutes with heptane (“solvent”) in an agitated vessel held at 60° C. The feed to solvent volumetric ratio was about 1:1. The liquid-liquid-solid dispersion was then placed into a vertical decantation vessel with straight vertical walls to allow the phases to settle by gravity. The decantation vessel was jacketed to maintain a constant temperature of the dispersion during the decantation process. Three distinct phases (or layers) separated in the decanter: 1) an extract phase (i.e., light separated liquid phase) at the top, 2) a biomass-rich phase in the middle, and 3) a raffinate phase (i.e., heavy separated liquid phase) at the bottom. Between these three phases, two interfaces were formed. An upper interface formed between the clear extract phase and the opaque biomass-rich phase. A lower interface also formed between a clear raffinate phase and the opaque biomass-rich phase. The location of these two interfaces was observed through sight glasses and recorded as a function of decantation time. The interface locations were converted into dimensionless depths by dividing the interface location distance from the bottom of the vessel by the total liquid depth in the decantation vessel. The location of these two interfaces allowed the decantation kinetics to be visually tracked, and the data are shown by squares in FIG. 3. The extract phase separated very slowly, as the upper interface took more than 75 minutes to approach within 90% the final dimensionless depth. The raffinate phase separated more quickly, as the lower interface took less than 30 minutes to approach 90% of the final dimensionless depth. Thus, the mean residence time for the extraction/decantation of the total dispersion in the mixer and settler to achieve 90% of the phase separation was 80 minutes when operated in batch mode.

### Example 9: Continuous Extraction of Oil from Algae at 60° C.

The batch results from Example 8 were used to compute the mean residence time for a mixer-settler operating in a continuous flow mode. In this process, both feed and solvent are continuously and steadily added to the mixer portion of a mixer-settler. The mean contact time between these phases in the agitated vessel is held constant at five minutes to allow for proper interfacial mass transfer. The dispersion is transferred to a gravity decanter, each phase is only retained by the amount of time necessary to allow 90% of that phase to be removed from the decanter as a pure (clear) phase. The mean residence time of the raffinate and extract phases are then chosen to be 30 and 75 minutes, respectively. The mean residence time for the extract phase in the continuous flow decanter is 75 minutes for 35% of the volumetric flow. The mean residence time for the raffinate phase in the continuous flow decanter is 30 minutes for the other 35% of the volumetric flow. Combined the total mean residence time of the continuous flow system is 5+25+10, or 40 minutes. Thus, the volume of the continuous-flow mixer-settler system is reduced by 45% when compared to the batch mode.

### Examples 10-24

The following experimental equipment and procedures were used for Examples 10-24. The liquid-liquid-solid extraction process was performed in a mixer-settler unit (a combined contacting and separating unit), for the isolation of natural products from algal biomass, where the cell membrane is likely disrupted, in an aqueous brine solution with a solvent. The mixing and settling were performed in the same vessel with the following geometrical parameters: 1) liquid depth in vessel to vessel diameter ratio=1; 2) baffle width=0.1×vessel diameter, with four equally spaced baffles that extended from the gas-liquid interface to the start of the bottom dish; 3) impeller diameter=0.5×vessel diameter; 4) 3-blade HE-3 impeller from Chemineer (Dayton, Ohio) was centrally mounted in the vessel, 5) a variable speed drive was used to control and set the agitation rate, 6) a condenser was used to retain the solvent while allowing the system to be swept with an inert gas, 7) the jacketed agitated vessel was fitted with sight glasses so that the mixing and decantation steps could be visually observed, and 8) the vessel was cylindrical with a shallow dish at the bottom with a bottom drain valve that is typical of agitated vessels used commercially. This agitated vessel served as both the mixer and settler in these examples. Thus, the impeller was operated during the mixing step, and it was turned off to initiate the settling step. The algal feed comprised algal biomass and brine that was initially charged to the agitated vessel. The heat transfer fluid in the jacket on the agitated vessel was set to the desired temperature for the run, and agitation was started at a rate to facilitate proper heat transfer. When the algal feed had reached the desired temperature for the run, the agitation rate was then increased to the desired impeller speed for the experiment, and the flow patterns were established with the algal feed before the first solvent was rapidly added to the agitated vessel at time zero for mixing. After the prescribed mixing time was reached, the impeller operation was stopped at time zero for decantation. The elevation in the vessel of the interface between the first extract and the first biomass layer was visually determined and recorded as a function of time during the decantation process. Likewise, the elevation of the interface between the first raffinate and the first biomass layer was visually determined and recorded as a function of time. In all examples, the decantation time for the gravity decantation process to approach 90% of the equilibrium value took more than 15 minutes for both liquid phases to separate. The interface elevations were converted to dimensionless depths by dividing the measured elevation above the bottom of the vessel by the total liquid elevation after the solvent had been added. The residence time for a decanter to achieve 90% separation is the decantation time necessary for the slowest interface to reach 90% of the equilibrium separation.

### Example 10: Single Stage Mixer-Settler Extraction—Comparative Example

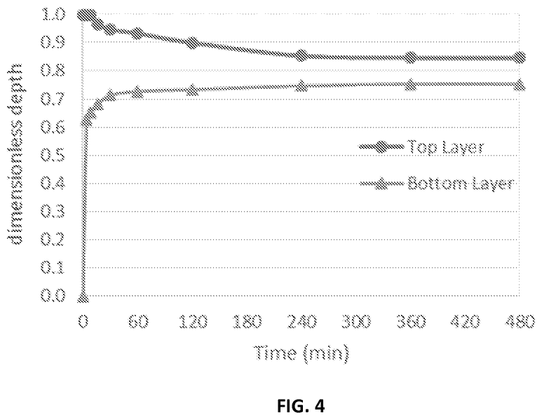

A 1 wt % dispersion of Dunaliella salina biomass in aqueous brine comprising 20 wt % sodium chloride salt was charged to the agitated vessel as the algal feed. Agitation and heating commenced to allow the algal feed to reach 50° C. The impeller speed was increased to the desired set point, and the first solvent (hexane) was rapidly added to achieve a solvent to feed volumetric ratio of 0.25. The impeller speed setpoint was 150% of the minimum impeller speed [Nmin] to completely disperse two immiscible liquid phases as defined by Skelland and Ramsay (Ind. Eng. Chem. Res. 1987, 26, 1, 77-81). The first liquid-liquid-solid dispersion was agitated for 10 minutes to facilitate mass transfer, and then the agitation ceased, and decantation commenced. The measured decantation curves are shown in FIG. 4 where the top curve corresponds to the elevation of the interface between the first light separated liquid phase and the first biomass-rich layer. This interface took about 200 minutes to achieve 90% of the equilibrium elevation. The bottom curve corresponds to the interface elevation of the first heavy separated liquid phase and the first biomass-rich layer, and this interface took more than 15 minutes to achieve more than 90% of the equilibrium elevation. When the decanted first heavy separated liquid phase was cleared, approximately 77 wt % of the algal feed charged to the mixer was removed via the bottom drain valve with a loss of about 13 wt % of the biomass charged. The carotenoid yield was 15 wt % and total fatty acid yield 25%. The required decantation time for 90% separation efficiency of the first light separated liquid phase was 200 minutes, which was the time required for the slowest interface to approach equilibrium. So, the combined mixing and decantation time to achieve 90% separation efficiency was 210 minutes.

Examples 11-19 were performed in the identical manner, and the results are shown in Tables 1 and 2.

TABLE 1
Examples 10-24 First extractor data

| A. | B. | C. | D. | E. | F. | G. | H | I. | J. | K. |
|---|---|---|---|---|---|---|---|---|---|---|
| 10 | 1 | 50 | 150 | Hexane | 0.25 | 10 | 77 | 13 | 15 | 25 |
| 11 | 1 | 50 | 150 | Hexane | 0.18 | 10 | 77 | 15 | 16 | 22 |
| 12 | 1 | 50 | 150 | Hexane | 0.11 | 10 | 79 | 17 | 14 | 13 |
| 13 | 1 | 50 | 150 | Hexane | 0.25 | 5 | 83 | 12 | 17 | 20 |
| 14 | 1 | 50 | 150 | Hexane | 0.25 | 20 | 82 | 11 | 22 | 38 |
| 15 | 3 | 50 | 150 | Hexane | 0.25 | 10 | 74 | 5 | 22 | 17 |
| 16 | 2 | 50 | 150 | Hexane | 0.25 | 10 | 87 | 7 | 23 | 20 |
| 17 | 2 | 70 | 150 | Heptane | 0.25 | 15 | 88 | 6 | 24 | 25 |
| 18 | 5 | 65 | 150 | Ethyl acetate | 0.25 | 15 | 85 | 2 | >99 | 60 |
| 19 | 7 | 75 | 150 | Limonene | 0.25 | 15 | 88 | 2 | 45 | 62 |
| 20 | 2 | 70 | 150 | Heptane | 0.25 | 15 | 88 | 6 | 18 | 24 |
| 21 | 2 | 70 | 150 | Heptane | 0.25 | 15 | 35 | 2 | 23 | 26 |
| 22 | 2 | 75 | 150 | Heptane | 0.25 | 15 | 38 | 3 | 11 | 23 |
| 23 | 2 | 75 | 150 | Heptane | 0.25 | 15 | 36 | 3 | 86 | 49 |
| 24 | 2 | 75 | 150 | Heptane | 0.25 | 15 | 36 | 14 | — | — |

Table 1 Column notations: (A) Example number; (B) Weight-% biomass in the feed; (C) Extraction and decantation temperature in ° C.; (D) Impeller speed as % of Nmin; (E) First solvent; (F) Solvent:feed volumetric ratio; (G) Agitation time in minutes (min); (H) First raffinate removed (wt % of brine in feed charged to vessel); (I) Approximate biomass loss in raffinate (wt %); (J) Carotenoid yield (wt %); (K) Fatty acids yield (wt %).

TABLE 2
Examples 10-23 First extractor decantation data

| A. | B. | C. | D. | E | F. |
|---|---|---|---|---|---|
| 10 | 10 | 30 / 16 / <4 | 240 / 200 / 120 | 26 | 210 |
| 11 | 10 | 16 / 8 / <4 | 360 / 300 / 240 | 18 | 310 |
| 12 | 10 | 5 / 4 / <4 | 360 / 240 / 120 | 14 | 250 |
| 13 | 5 | 30 / 10 / 3 | 360 / 300 / 240 | 15 | 305 |
| 14 | 20 | 20 / 9 / 4 | 480 / 420 / 360 | 29 | 440 |
| 15 | 10 | 60 / 30 / 8 | 480 / 360 / 240 | 40 | 370 |
| 16 | 10 | 30 / 12 / 6 | 480 / 240 / 180 | 22 | 250 |
| 17 | 15 | 18 / 10 / 3 | 240 / 120 / 80 | 25 | 135 |
| 18 | 15 | 360 / 300 / 140 | no separation in 1350 min | 315 | >1365 |
| 19 | 15 | 540 / 420 / 180 | no separation in 1350 min | 435 | >1365 |
| 20 | 15 | 14 / 8 / 3 | 120 / 100 / 60 | 23 | 115 |
| 21 | 15 | 16 / 10 / 3 | 120 / 100 / 60 | 25 | 115 |
| 22 | 15 | 16 / 12 / 4 | 120 / 100 / 60 | 27 | 115 |
| 23 | 15 | 4 / 2 / 0.5 | no separation in 120 min | 17 | >135 |

Table 2 Column Notations: (A) Example number; (B) Mixing time; (C) Decantation time to achieve 95% / 90% / 70% approach to equilibrium interface level for first raffinate; (D) Time to achieve 95% approach to equilibrium interface level for first extract; (E) Total residence time (=mixing time + settling time) needed for 90% decantation of fastest settling layer with a single mixer-settler; (F) Total residence time needed for 90% decantation of slowest settling layer with a single mixer-settler.

### Example 20: Two Stage Mixer Settler System

The objective of this experiment was to determine the time needed to achieve 90% separation efficiency in a single decanter and then quantify the reduction in mixer-decanter volume that can be achieved by adding a second mixer-decanter. The first extraction stage in this example was performed in an identical method to that described in the text for Example 10. However, in this Example, a second stage of extraction was performed on the first extract and first biomass layer that remained in the agitated vessel after the first raffinate was almost completely removed from the first extractor. In the second extractor, the impeller was lowered to an elevation of 0.225×vessel diameter after the first raffinate was removed. The second solvent of heptane was added, and the contents of the vessel were heated to 70° C. Once the vessel contents reached the desired temperature, agitation commenced, and the impeller speed was increased to 200% of the minimum impeller speed for complete dispersion of the two phases. The liquid-liquid-solid dispersion was agitated for 15 minutes in a mixing mode to facilitate mass transfer. After mixing, the agitation was stopped, and the phases were allowed to decant. In this example, most of the raffinate phase had been removed, so that the second extract phase and the second biomass layer separated almost immediately in five minutes and a second raffinate phase did not form. Thus, the residence time for the first mixing was 15 minutes, and the first decantation time needed to achieve 90% interface approach of the first raffinate phase was 8 minutes. Thus, the total residence time for the first mixer-settler system was 23 minutes. Also note that if only the first mixer-settler was used, the decantation residence time for the first extract to achieve 90% interface approach was 115 minutes. Compare this value to that for the combined first and second mixer-settler combination. The residence time in the first mixer-settler was already discussed, at 23 minutes. The overall residence time for the second mixer-settler was 15 minutes (10 minutes for mixing and 5 minutes for decantation). Therefore, the overall residence time of the two mixer-settler system was 38 minutes versus 115 minutes for a single mixer-settler. Thus, the conditions of the second extraction step were modified relative to those in the first extraction step so that the overall residence time in the mixer-settler vessel was reduced from 115 to 38 minutes by adding the second extraction phase, and the overall system volume correspondingly reduced by 67%.

### Example 23

After the first extraction step was performed as described in Example 10, this time with Dunaliella salina algae grown at stressed conditions, only about 36% of the first raffinate phase was removed by the bottom drain valve. The remainder of the first raffinate along with the first extract phase and first biomass layer were left in the vessel. The second solvent was then added to the vessel, and the volume of this second solvent was enough to replace the volume of the first raffinate that was removed. The impeller location was held constant with that for the first extraction step in these examples. The contents of the vessel were heated to the desired extraction temperature of 75° C. before agitation commenced. The liquid-liquid-solid dispersion was intimately contacted at 150% of the minimum impeller speed to completely disperse the liquid-liquid dispersion for a period of 10 minutes. After the three phases were contacted, the agitation was stopped, and decantation curves were again collected as described in Example 10. More than 90% of the phase separation between the second raffinate phase and the biomass layer was accomplished after 8 minutes. The 90% decantation time for the top phase occurred in less than 5 minutes. Thus, the combined mixer-settler residence time for the 1-stage mixer-settler process required more than 135 minutes. However, the 2-stage mixer-settler process only required 17+18 minutes.

Examples 21 and 22 were performed in the identical manner, but with algae grown under similar conditions as in examples 10-20, and the results are shown in Tables 3 and 4 for the second extraction, while the results for the first extraction are given in Tables 1 and 2 above.

### Example 24

Example 24 was performed in an identical manner as the first extraction step in Example 23, but this time with algal biomass that was spoiled prior to the extraction step by exposing the algal biomass to 35° C. for 7 days of time with air present. The biomass loss to the first raffinate was measured at 14%, which is almost 5 times more than in Example 23, which was performed with fresh biomass. Thus, the phase separation was significantly poorer in the extractor, which also could be visually determined.

TABLE 3
Examples 20-23 Second extractor data

| A. | B. | C. | D. | E. | F. | G. | H. | I. | J. |
|---|---|---|---|---|---|---|---|---|---|
| 20 | 28 | 70 | 200 | 0.225 | 8.35 | 10 | 0 | 32 | 38 |
| 21 | 80 | 70 | 200 | 0.225 | 0.94 | 10 | 3.9 | 37 | 38 |
| 22 | 77 | 75 | 150 | 0.5 | 0.99 | 10 | 3.1 | 20 | 39 |
| 23 | 79 | 75 | 150 | 0.5 | 0.90 | 10 | 3.5 | 96 | 65 |

Table 3 Column notations: (A) Example number; (B) Feed to second extractor as fraction (%) of first extractor feed; (C) Extraction and decantation temperature (° C.); (D) Impeller speed as % of Nmin; (E) Impeller location as dimensionless height of total liquid height; (F) Solvent:feed volumetric ratio; (G) Agitation time in minutes (min); (H) Approximate biomass loss in raffinate (wt %); (I) Total carotenoid yield (wt-%) in extractor 1 and 2; (J) Total fatty acids yield (wt-%) in extractor 1 and 2.

TABLE 4
Examples 20-23 Decantation data for second
extractor 2 and overall performance

| A. | B. | C. | D. | E. | F. | G. | H. |
|---|---|---|---|---|---|---|---|
| 20 | 10 | <1 / <1 / < 1 | <5 | 23 | 38 | 115 | 67% |
| 21 | 10 | 16 / 12 / 5 | <5 | 25 | 47 | 115 | 59% |
| 22 | 10 | 20 / 12 / 4 | <5 | 27 | 49 | 115 | 57% |
| 23 | 10 | 12 / 8 / 2 | <5 | 17 | 35 | >135 | >74% |

Table 4 Column notations: (A) Example number; (B) Mixing time in second extractor; (C) Decantation time to achieve 95% / 90% / 70% approach to equilibrium interface level for bottom layer; (D) Decantation time to achieve 90% approach to equilibrium interface level for top layer; (E) Total residence time needed for 90% decantation of fastest settling layer with a single decanter; (F) Total residence time needed for both phases to reach overall 90% decantation in the two mixer-settlers; (G) Total residence time needed for both phases to reach 90% decantation in one mixer-settler; (H) Percent reduction of overall mixer-settler volume comparing two-stages to one stage (=(G − F)/G*100%).

It will be appreciated by those skilled in the art that the present disclosure can be embodied in other specific forms without departing from the spirit or essential characteristics thereof. The presently disclosed embodiments are therefore considered in all respects to be illustrative and not restricted. The scope of the disclosure is indicated by the appended claims rather than the foregoing description and all changes that come within the meaning and range and equivalence thereof are intended to be embraced therein.

1. A liquid-liquid-solid extraction process for recovering products from a feed stream containing biomass, the process comprising:
receiving the feed stream from a source;
contacting the feed stream with a first solvent in a first contacting unit to form a first dispersion;
allowing the first dispersion to phase separate into a first separated liquid phase and a first remaining dispersion;
removing at least a portion of the first separated liquid phase;
contacting the first remaining dispersion with a second solvent in a second contacting unit to form a second dispersion;
allowing the second dispersion to phase separate into a biomass-rich phase, a heavy separated liquid phase and a light separated liquid phase; and
recovering at least one or more of the biomass-rich phase, the heavy separated liquid phase, and/or the light separated liquid phase for output as products.

2. The process of claim 1, the process comprising at least one of the following:
transferring the first remaining dispersion to at least one auxiliary contacting unit and/or separating unit before the contacting the first remaining dispersion with the second solvent in the second contacting unit; or
transferring the second dispersion to at least one auxiliary contacting unit and/or separating unit before the second dispersion is phase separated into the biomass-rich phase, the heavy separated liquid phase and the light separated liquid phase.

3. The process according to claim 1, wherein the salinity of the heavy separated liquid phase is greater than about 5, 10, 15, or 20 wt % salt.

4. The process according to claim 1, wherein the first contacting unit comprises at least one or more of a mixer-settler unit, a counter-current extraction column, a co-current extraction column, a centrifugal extractor, membrane extractors, an emulsion phase contactor, any extractor that relies upon non-standard contact methods or any combination thereof.

5. The process according to claim 1, wherein the first solvent comprises any one or more of a non-polar solvent, a non-polar organic solvent, a light solvent, a light organic solvent, a dense gas solvent, an aqueous two-phase solvent, an ionic liquid and/or combinations thereof.

6. The process according to claim 1, wherein the allowing of the first dispersion to phase separate into the first separated liquid phase and the first remaining dispersion comprises retaining the feed stream in a first separating unit for a set period of time until the first separated liquid phase and the first remaining dispersion form.

7. The process according to claim 1, wherein the first separated liquid phase and the first remaining dispersion require at least 30 minutes under gravitational acceleration to phase separate.

8. The process according to claim 1, wherein the first separated liquid phase contains a higher concentration of an aqueous solution than the first remaining dispersion.

9. The process according to claim 1, the process comprising recovering products from at least one or more of the separated biomass-rich phase, the heavy separated liquid phase, and/or the light separated liquid phase, the products including at least one of lipids, algal lipids, carotenoids, fatty acids, algal fatty acids, triacylglycerols, diacylglycerols, monoacylglycerols, oils, algal oils and any combination thereof.

10. The process according to claim 1, the process comprising performing a temperature and/or pressure adjustment before the feed stream contacts the first solvent in the first contacting unit, before the first solvent enters the first contacting unit, during the contacting of the feed stream with the first solvent in the first contacting unit and/or any combination thereof.

11. The process according to claim 1, wherein the second contacting unit comprises at least one or more of a mixer-settler unit, a counter-current extraction column, a co-current extraction column, a centrifugal extractor, membrane extractors, an emulsion phase contactor, any extractor that relies upon non-standard contact methods or any combination thereof.

12. The process according to claim 11, wherein the second contacting unit is at least one counter-current extraction column.

13. The process according to claim 1, wherein the second solvent comprises any one or more of a non-polar solvent, a non-polar organic solvent, a dense gas solvent, an aqueous two-phase solvent, an ionic liquid and/or combinations thereof.

14. The process according to claim 1, wherein the biomass is or comprises at least one or more of a plant biomass, a microbial biomass, an algal biomass and/or any combination thereof.

15. The process according to claim 1, wherein the feed stream is freshly prepared.

16. The process according to claim 1, wherein the allowing of the first dispersion to phase separate into the first separated liquid phase and the first remaining dispersion and/or the allowing of the second dispersion to phase separate into the biomass-rich phase, the heavy separated liquid phase and the light separated liquid phase occurs under a gravitational field.

17. The process according to claim 1, wherein the allowing of the first dispersion to phase separate into the first separated liquid phase and the first remaining dispersion comprises maintaining a first solvent to feed stream ratio of 0.1 to 10 and/or a flux of 10 m³/h/m² to 80 m³/h/m³.

18. The process according to claim 1, wherein the first separated liquid phase reaches 90% of a dimensionless height asymptote within 30 minutes (t(settle)<30 min) during the phase separation of the first dispersion into the first separated liquid phase and the first remaining dispersion.

19. The process according to claim 1, wherein the first separated liquid phase and the first remaining dispersion have a settling time ratio at DH90 of about 0.8 or less.

20. The process according to claim 1, the process comprising at least one or more of:
filtering the biomass-rich phase after separating from the heavy separated liquid phase and the light separated liquid phase to remove any entrained solvent and/or hydrophobic natural products;
filtering the light separated liquid phase after separating from the biomass-rich phase and the heavy separated liquid phase to recover any entrained biomass; and/or
filtering the heavy separated liquid phase after separating from the biomass-rich phase and the light separated liquid phase to remove any entrained solvent and/or any entrained biomass.

21. The process according to claim 1, wherein the light separated liquid phase includes the first solvent and the process comprises evaporating the first solvent from the light separated liquid phase after separating the light separated liquid phase from the heavy separated liquid phase and the biomass-rich phase.

22. The process according to claim 1, wherein the biomass-rich phase forms below the light separated liquid phase.

23. The process according to claim 1, wherein the allowing of the first dispersion to phase separate into the first separated liquid phase and the first remaining dispersion occurs in the first contacting unit.

24. The process according to claim 1, wherein the allowing of the second dispersion to phase separate into the biomass-rich phase, the heavy separated liquid phase and the light separated liquid phase occurs in the second contacting unit.

25. The process according to claim 24, wherein the separating of at least one or more of the biomass-rich phase, the heavy separated liquid phase, and/or the light separated liquid phase for output as recovered products comprises removing at least one or more of the biomass-rich phase, the heavy separated liquid phase, and/or the light separated liquid phase from the second contacting unit.

26. A system for recovering products from a feed stream containing biomass, the system comprising:
a feed stream import line;
a first contacting unit in communication with the feed stream import line;
a first solvent import line in communication with the first contacting unit;
a first effluent export line in communication with the first contacting unit;
a second contacting unit in communication with the first contacting unit;
a second solvent import line in communication with the second contacting unit; and
a first extraction line in communication with the second contacting unit.

27. The system according to claim 26, wherein the first contacting unit and/or the second contacting unit comprises at least one or more of a mixer-settler unit, a counter-current extraction column, a co-current extraction column, a centrifugal extractor, membrane extractors, an emulsion phase contactor, any extractor that relies upon non-standard contact methods and/or any combination thereof.

28. The system according to claim 26, wherein the feed stream import line, the first solvent import line, the first effluent export line, the second solvent import line and/or the first extraction line is a pipe, a tube or a canal.

29. The system according to claim 26, the system comprising:
a second extraction line in communication with the second contacting unit; and
a third extraction line in communication with the second contacting unit.

30. The system according to claim 29, wherein the first extraction line is configured to remove a light separated liquid phase from the second contacting unit, the second extraction line is configured to remove a biomass-rich phase from the second contacting unit, and the third extraction line is configured to remove a heavy separated liquid phase from the second contacting unit.

31. The system according to claim 26, wherein the first contacting unit and the second contacting unit are counter-current extraction columns.

32. The system according to claim 26, the system further comprising at least one auxiliary contacting unit and/or separating unit.

33. A method for designing a liquid-liquid-solid extraction process for recovering products from a feed stream comprising biomass, the method including:
intimately contacting the feed stream and a first extraction solvent, optionally at a temperature from 5° C. to 90° C., in a first contacting unit and measuring the decantation curves that form upon and/or during contact in a first separating unit, in which the first dispersion phase separates into a first separated liquid phase and a first remaining dispersion;
selecting a phase with the shortest time to reach 90% of a dimensionless height asymptote and removing a desired amount of said phase from the first separating unit before passing a first remaining dispersion to a second contacting unit;
intimately contacting the first remaining dispersion with a second solvent and determining the decantation curves formed upon and/or during contact in the second contacting unit, in which second dispersion phase separates into a biomass-rich phase, a heavy separated liquid phase and a light separated liquid phase; and
selecting operating parameters for the second contacting unit and a second separating unit to optimize the overall extraction costs of the method.
